(19) United States
(12) Patent Application Publication
(10) Pub. No.: US 2014/0014586 A1
(43) Pub. Date: Jan. 16, 2014

(54) TREATMENT OF WASTEWATER

(71) Applicant: Soane Energy, LLC, Cambrigde, MA (US)

(72) Inventors: David S. Soane, Chestnut Hill, MA (US); Robert P. Mahoney, Newbury, MA (US); Ian Slattery, Cambridge, MA (US)

(73) Assignee: Soane Energy, LLC

(21) Appl. No.: 13/713,671

(22) Filed: Dec. 13, 2012

Related U.S. Application Data
(63) Continuation-in-part of application No. 13/450,815, filed on Apr. 19, 2012.

(51) Int. Cl. C02F 1/52

(52) U.S. Cl. CPC C02F 1/5281
USPC 210/666; 210/202; 210/665; 210/667

(57) ABSTRACT

The present invention provides systems and methods for removing an oxidizable target contaminant from a fluid, and methods for their use. In embodiments, these systems and methods include an oxidizing agent, wherein adding the oxidizing agent to the oxidizable target contaminant forms an oxidized species that precipitates as an insoluble precipitate in the fluid; a substrate that forms a removable complex with the insoluble precipitate, thereby sequestering the oxidizable contaminant, and a removal system for removing the removable complex from the fluid.

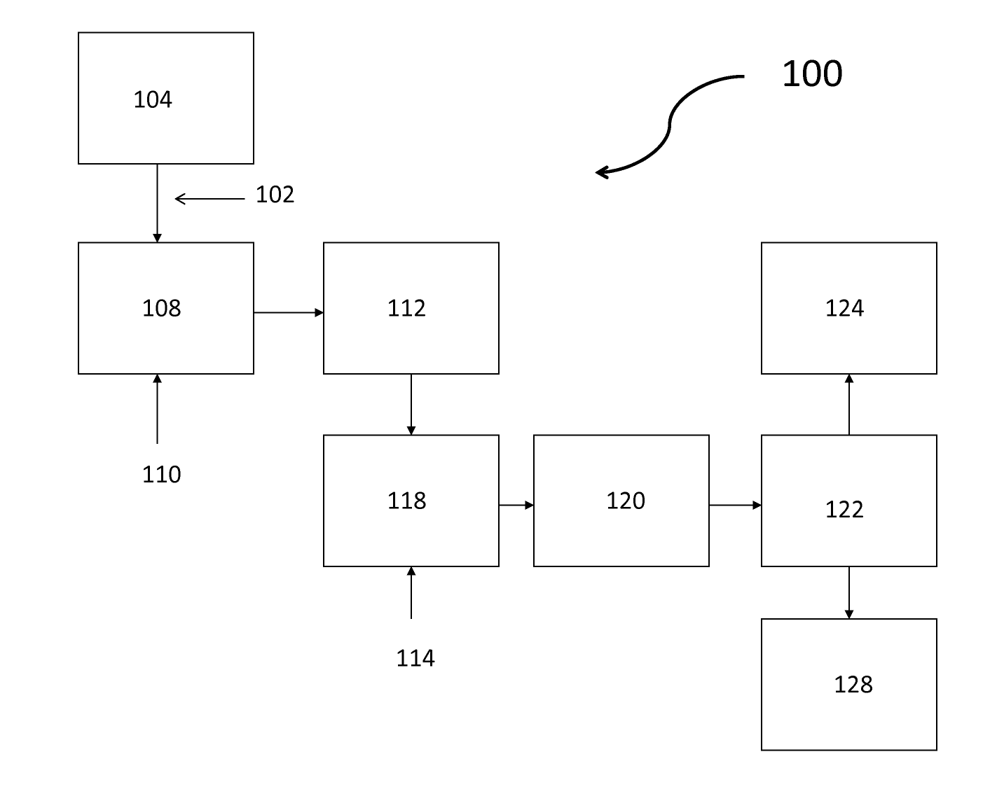

### RELATED APPLICATIONS

This application is a continuation-in-part of U.S. application Ser. No. 13/450,815 filed Apr. 19, 2012, which claims the benefit of U.S. Provisional Application Ser. No. 61/477,277 filed Apr. 20, 2011, and U.S. Provisional Application Ser. No. 61/570,115 filed Dec. 13, 2011; this application also claims the benefit of U.S. Provisional Application Ser. No. 61/570,115, filed Dec. 13, 2011, and U.S. Provisional Application Ser. No. 61/721,853, filed Nov. 2, 2012. The entire contents of the above applications are incorporated by reference herein.

### FIELD OF APPLICATION

This application relates generally to systems and methods for removing contaminants from water and wastewater.

### BACKGROUND

Certain undesirable materials are found to be contaminants in water and wastewater. Water streams can be contaminated with substances like iron, manganese, organic matter, suspended solids, hydrogen sulfide, or bacteria. Iron causes taste and odor problems in potable water, causes staining in laundry, wash, swimming pool, or process water, and it causes fouling and deposits in boiler and cooling water systems. In many aqueous systems such as drain water, bilge water, grease traps, and holding tanks, odors can be caused by sulfides, mercaptans, and organic matter. These odors can be treated by oxidizing agents, but the oxidizers can be difficult to administer in low-flow or unattended areas. There remains a need for improved methods to treat metals, organics, bacteria, suspended solids, and odor compounds in water streams.

Wastewater management is a major problem in the petroleum industry. Petroleum industry wastewater includes oilfield produced water and aqueous refinery effluents. Petroleum industry wastewater also includes flowback water from hydraulic fracturing of oil-containing or natural-gas-containing geological formations.

Contaminants found in oilfield produced water, flowback water, and aqueous refinery effluents can include, at varying levels, materials such as: (1) dispersed oil and grease, if not removed by mechanical pretreatment separators can clog post-treatment equipment; (2) benzene, toluene, ethylbenzene and xylenes (BTEX), a volatile fraction; (3) water-soluble organics; (4) sparingly soluble nonvolatile organics, including aromatics with molecular weights higher than BTEX but lower than asphaltenes; (5) treatment chemicals, such as drilling, completion, stimulation and production chemicals; (6) produced solids like clays, silicates and metal sulfides, usually removed by mechanical separators; and (7) total dissolved solids including metals, a particular problem because many metals are considered toxic. A variety of treatments are available to remove these contaminants, including the use of organophilic clays, activated carbon type adsorbents, ion exchange resins, coalescers, coagulants, filters, absorbers, alpha hydroxy acids, dithiocarbamates for metals, and media filtration. There remains a need in the art, however, to identify more effective, efficient and cost-conscious solutions to these wastewater problems.

The urgency for improved wastewater management in the petroleum industry is heightened by rising public concern over environmental hazards and toxicities. For selenium, as an example, the U.S. Environmental Protection Agency (EPA) plans to incorporate new discharge limits as low as 5 ppb. Current technologies for selenium removal include adsorption & precipitation, ion exchange, chemical or biological reduction, oxidation, and membrane treatment (nano-filtration or reverse osmosis). Even using these methods, it may be difficult and costly to meet the standards that the EPA is considering. Zinc and its compounds are another set of regulated inorganic contaminants in petroleum refinery wastewater. These compounds originate from many sources within a refinery including artificial addition, and require end-of-pipe treatment. Zinc compounds and other metals can be removed from wastewater using technologies such as lime precipitation, coagulation & flocculation, activated carbon adsorption, membrane process, ion exchange, electrochemical process, biological treatment, and chemical reaction to achieve in practical large scale. Some regulatory agencies have set discharge limits for these and other metals that exceed the capacity for commercial metals removal processes. A pressing need exists to improve methods for removing metals from wastewater in light of the increasing regulatory scrutiny of such wastewater contaminants.

Petroleum industry wastewater also includes water used for hydraulic fracturing. In the recovery of oil and gas from geological formations, hydraulic fracturing is a process of pumping fluids into a wellbore at high pressures to fracture the hydrocarbon-bearing rock structures. This fracturing increases the porosity or permeability of the formation and can increase the flow of oil and gas to the wellbore, resulting in improved recovery. Hydraulic fracturing for hydrocarbon-containing formations typically uses water obtained from two sources: 1) surface water derived from water wells, streams, lakes, and the like, that has not been previously used in the fracturing process; and 2) water that has been used in, and/or flows back from fracturing operations (“frac flowback water”). Processes exist for treating both surface and flowback water sources to prepare them for use or re-use in hydraulic fracturing. Without appropriate treatment, contaminants entering the frac water can cause formation damage, plugging, lost production and increased demand for further chemical additives.

Frac flowback water typically contains contaminants that were introduced into the system during the hydraulic fracturing process. Such contaminants may be introduced from the surface water originally used in the process, or they may enter the flowback water from its previous exposure to the reservoir. These contaminants include dissolved metals, salts, and organics, dispersed particulates, and organics emulsions. Such contaminants alter the properties of the fluid and can prevent their reuse as a hydraulic fracturing fluid.

For example, iron in hydraulic fracturing water can cause corrosion, plugging of downhole formations and equipment, an elevated demand for frac additive chemicals, and membrane fouling in treatment processes. Techniques available for removing iron from frac water include aeration and sedimentation, softening with lime soda ash, and ion exchange. Aeration and other chemical oxidation practices are known for household well water treatment to remove iron. Oxidation converts the soluble iron II (Fe⁺²) form to the less soluble iron III (Fe⁺³) oxidation state, causing it to precipitate, often as iron hydroxide, which is collected by filtration or sedimentation. Greensand iron removal is one of the typical methods. However, greensand impregnated with potassium permanganate is only capable of treating iron concentrations up to a few ppm, while the iron concentration in oilfield frac flowback water and produced water can be as high as 300 ppm. Current methods of oxidant encapsulation and controlled release for soil and ground water remediation are not suitable for oilfield frac flow back water iron removal since the oxidant release rate is too slow for continuous flow through process. Ion Exchange and chelating resins cannot remove iron effectively from frac flowback water due to the co-existence of the high concentrations of other multivalent cations. There remains a need in the art, therefore, to provide water treatment systems and methods that can remove iron contaminants effectively from water to be used in hydraulic fracturing, especially frac flowback water, where iron contaminants reach high levels.

Furthermore, in many solid-liquid separators the removal of gelatinous particles such as iron hydroxides and other metal hydroxides is a challenge. Filtration is one method of removal, although it has significant challenges to overcome. Small gelatinous particles can pass through all but the finest openings. Filters for their removal can quickly become plugged, especially with high concentrations of particles. When this happens, the only way to restore effective operation is to either backwash or replace the filter, both of which will typically cause disruptions the process continuity. Gelatinous particles can also be removed through clarification. This method tends to be preferable to filtration for higher concentrations of particles. Clarifiers allow particles sufficient time to settle out by spontaneous separation due to density. Often a flocculant is used to bind small particles together, which improves their settling rate. The faster the settling rate of the particle impurities, the smaller the clarifier needs to be. Even when flocculants are used with clarifiers, these agents have a limited efficacy. Additionally, the underflow from these clarifiers is typically high in water concentration.

Larger, denser gelatinous particles are easier to separate from water and retain less water in the solids concentrate stream. Thus they settle faster, requiring smaller settling tanks. They do not deform when filtered, and therefore do not plug the filter as quickly. They can even be used in continuous filter operations, with the filtered particles being removed from the filter during operation, preventing the need for downtime. There remains a need in the art, therefore, for systems and methods to remove gelatinous particles from fluid streams, especially fine gelatinous particles. It would be desirable to incorporate these systems and methods into an integrated water treatment system with other treatment modalities to interface with the hydraulic fracturing processes efficiently, and that prepare water in a cost-effective way for use in these processes.

Taken generally, the on-site removal of the various contaminants in frac flowback water allows it to be used in subsequent hydraulic fracturing operations, providing significant benefits due to reduced costs and environmental impact. The capability for on-site treatment of frac flowback water is particularly advantageous, because it does not require the transportation of the water to and from off-site treatment facilities.

### SUMMARY

Disclosed herein, in embodiments, are systems and methods for water treatment, comprising one or more systems selected from the group consisting of: a bacteria-removal substrate modifier system; a dissolved-metals removal substrate-modifier system; a suspended-solids removal substrate-modifier system; a hardness-removal system; an organic-removal or oil-removal substrate-modifier system; and an oxidizing agent technology system. In an exemplary embodiment, the system comprises a dissolved-metals removal substrate-modifier system; a suspended-solids removal substrate-modifier system; and an oxidizing agent technology system. Further disclosed herein, in embodiments, are systems and methods for removing an oxidizable target contaminant from a fluid, comprising: an oxidizing agent, wherein adding the oxidizing agent to the oxidizable target contaminant forms an oxidized species that precipitates as an insoluble precipitate in the fluid; a substrate that forms a removable complex with the insoluble precipitate, thereby sequestering the oxidizable target contaminant; and a removal system for removing the removable complex from the fluid. In embodiments, the oxidizable target contaminant comprises iron. In embodiments, the substrate comprises diatomaceous earth. In embodiments, the insoluble precipitate is modified to form a flocculated precursor having affinity for the substrate, whereby flocculated precursor complexes with the substrate to form the removable complex. In embodiments, the removable complex comprises an agglomerate comprising the substrate and the flocculated precursor, the flocculated precursor comprising the insoluble precipitate. In embodiments, the substrate is a modified substrate, which can comprise anchor particles. In embodiments, the anchor particles are tether-bearing anchor particles. In embodiments, the system further comprises an activator added to the fluid, wherein the activator binds to the insoluble precipitate. In embodiments, the removable complex comprises an anchor particle, a tether polymer attached thereto, and an activator that binds to the tether and that binds to the insoluble precipitate. In embodiments, the anchor particles can be less dense than the fluid. In embodiments, the anchor particles can comprise gas bubbles, which may be formed by a chemical action of the oxidizing agent. In embodiments, the system may further comprise a hydrophobic modifier.

Further disclosed herein, in embodiments, are methods for removing a dissolved contaminant from a fluid stream, comprising: converting the dissolved contaminant to an insoluble form; introducing an anchor particle into the fluid stream, wherein the anchor particle has an affinity for the insoluble form to form a removable complex therewith; and removing the removable complex from the fluid stream. In embodiments, the anchor particle is less dense than the fluid stream. In embodiments, the anchor particle comprises gas bubbles. In embodiments, the affinity of the anchor particle for the insoluble form is mediated by a tether polymer attached to the anchor particle. In embodiments, the method further comprises adding an activator polymer to the fluid stream, wherein the activator particle attaches to the insoluble form to produce a flocculated complex attachable to the anchor particle. In embodiments, the dissolved contaminant comprises iron, and the step of converting the dissolved contaminant to the insoluble form comprises oxidizing the iron. In embodiments, the insoluble form is an insoluble precipitate. In embodiments, the removable complex comprises gas bubbles. In embodiments, a hydrophobic activator may be added to the fluid stream, wherein the hydrophobic activator attaches to the insoluble form to produce a hydrophobic complex attachable to the anchor particle.

In other embodiments, methods are disclosed herein for removing a metal ion species from a fluid stream, where the metal iron species is a soluble metal ionic species, and where the steps of the method include oxidizing the soluble metal ion species with an oxidizing agent to form an insoluble oxidized species; flocculating the insoluble oxidized species to form flocculated particulates; providing a substrate that has affinity for the flocculated particulates; introducing the substrate into the fluid stream to contact the flocculated particulates, whereby contacting the substrate with the flocculated particulates forms a removable complex; and removing the removable complex from the fluid stream, thereby removing the metal ion species. The metal ion species can be a ferrous ion. The substrate can comprise diatomaceous earth, and the substrate can be combined with an additive comprising the metal ion species in an oxidized or a reduced state. In an embodiment, the substrate comprises diatomaceous earth and the additive comprises a ferrous ion. In an embodiment, the substrate comprises diatomaceous earth and the additive comprises a ferric ion. In an embodiment, the substrate can be coated with the additive, and the substrate can be diatomaceous earth and the additive coating can comprise a ferrous or a ferric ion.

### BRIEF DESCRIPTION OF FIGURE

The FIGURE is a diagram of a water treatment system in accordance with these systems and methods.

### DETAILED DESCRIPTION

Disclosed herein are systems and methods for removing contaminants from an aqueous stream using systems and methods that add treatment agents comprising anchor particles and tethers, with optional activating agents or activators, all as described below in more detail. The anchor particles and tethers, with optional addition of activators, can remove the contaminants from the fluid stream by forming removable complexes with them. In embodiments, these systems and methods may be applied to particular applications, for example removal of contaminants in aqueous streams associated with the petroleum industry.

A. Contaminant Removal from Aqueous Streams

1. Anchor Particles, Tethers and Activators Generally

In certain embodiments, target contaminants are made insoluble by addition of precipitating agent or by chemical reaction such as oxidation. The insoluble solids thus formed are then bound to an added particle, yielding a removable complex which has superior separation characteristics compared to the solids. Such particles (termed “anchor particles” and discussed below in more detail) may be modified to target dissolved contaminants, thereby making them insoluble or immobilized. Removable complexes form between the anchor particles and the target contaminants, and these particle-solid complexes can be removed by ordinary techniques such as particle filtration or settling.

In the disclosed systems and methods, contaminants can be removed from an aqueous stream by converting the contaminants into a form that is easier to remove, and then removing the contaminants. In embodiments, difficult-to-separate particles are bound to easy-to-separate particles to take advantage of the separation properties of the latter. In embodiments, the separation properties of the easy-to-separate particles include rapid settling, rapid rising, rapid floating, rapid centrifuging, or rapid filtering. The easy-to-separate particles, the “anchor particles,” form removable complexes with the difficult-to-separate particles, called “target particles.” Exemplary anchor particles are coarse sand and cellulose fibers. An exemplary target particle is precipitated ferric hydroxide.

As used herein, the term “anchor particle” refers to a particle that facilitates the separation of fine particles from a fluid stream, where such a particle can have any shape or size, including spherical, amorphous, flake, fiber, or needle morphology, and where such a particle can be made of organic or inorganic materials, gas bubbles, or a combination thereof. Organic materials for anchor particles can include one or more materials such as starch, modified starch, polymeric spheres (both solid and hollow), and the like. Anchor particle sizes can range from a few nanometers to few hundred microns. In certain embodiments, macroscopic particles in the millimeter range may be suitable. In embodiments, an anchor particle may comprise materials such as lignocellulosic material, cellulosic material, minerals, vitreous material, cementitious material, carbonaceous material, plastics, elastomeric materials, and the like. In embodiments, cellulosic and lignocellulosic materials may include wood materials such as wood flakes, wood fibers, wood waste material, wood powder, lignins, cellulose fibers, wood pulp, or fibers from woody plants.

In embodiments, the anchor particle can be added from an extrinsic source. In embodiments, the anchor particle can be produced intrinsically, for example by the formation of gas bubbles through chemical means during the separation process. In embodiments, the anchor particle can be denser than the medium containing the contaminants. Contaminants that complex with such anchor particles tend to sink out of suspension, allowing their separation via gravity, centrifugation, and the like. In other embodiments, the anchor particle can be less dense than the medium containing the contaminants. Contaminants that complex with such anchor particles tend to float towards the surface of a suspension, allowing their separation via skimming or other mechanical means. In embodiments, the anchor particle can have a density similar to that of the fluid stream, so that it neither floats nor sinks, but remains in suspension. Such neutral buoyancy complexes can be removed by conventional means such as filtration, centrifugation, and the like.

In certain contaminated water sources, such as those having a high Total Dissolved Solids (TDS) content of 50,000-150,000 ppm, or in some cases 150,000-350,000 ppm or greater, the precipitated contaminants (i.e., target particles) are amenable to flotation, in part due to the higher density of the water and in part due to the higher surface tension. For situations where flotation represents a more suitable approach to contaminant removal, anchor particles can be selected that have a lower density than the fluid stream, so that the contaminants complexed thereto can be removed by flotation. Anchor particles having a density lower than the density of the aqueous stream, such as hollow anchor particles or gas bubbles, facilitate the floating of target particles for removal as a flotation sludge.

In certain embodiments, a low density anchor particle may include a gas bubble, such as air, nitrogen, oxygen, carbon dioxide, methane, propane, butane, and mixtures thereof. The gas bubbles can be introduced to the aqueous stream by chemical means or by mechanical means; they may be introduced extrinsically or produced intrinsically. The chemical means of intrinsic gas bubble introduction can include the reaction or decomposition of gas-evolving substances, such as peroxides, azo compounds, carbonates, bicarbonates, gas hydrates, and the like. The use of some oxidants, such as hydrogen peroxide and bleach, can cause bubble generation within the system. One mechanism of bubble formation by hydrogen peroxide is the decomposition of peroxide in the presence of iron or enzymes such as catalase, causing the release of oxygen. Bleaching chemicals such as sodium hypochlorite can release chlorine-containing gases, including chloramines when reacting with residual ammonia or ammonium in the water. The gas bubbles generated by these reactions can deposit themselves onto the flocs, and after sufficient bubble attachment the bubbles make the flocs buoyant and float. Mechanical means for extrinsic gas bubble introduction can include air entrainment, pump cavitation, gas sparging, gas diffusing, impingement, sonication, and dissolved gas evolution. In embodiments the gas bubble anchor particles have an average diameter of 10-1000 microns.

In one embodiment, an anchor particle can be modified to promote its binding to a target particle. The modifying agent is called a “tether,” a material that has a specific affinity with an untreated and/or a modified target particle. As an example, an anchor particle can be treated prior to use with a cationic polymer such as poly(diallyldimethyl ammonium chloride) (PDAC), epichlorohydrin/dimethylamine polymer, chitosan, polyethylenimine, polyallylamine, poly(styrene/maleic anhydride imide), and the like, which will act as a tether in interactions with the target particle. In these embodiments, anchor particles can be attached to the tether as a separate step, with the tether-bearing anchor particles then added to the fluid stream containing the target particles. In other embodiments, a cationic polymer can be added to the fluid containing the target particles simultaneously with or separately from the addition of the anchor particles, so that tether-bearing anchor particles are not formed as a separate step. In either case, a tether, for example a cationic tether such as PDAC, can bind to anionic target particles or target particles that have been modified so as to become anionic.

The tether can attach to the anchor particle by electrostatic attraction, hydrophobic attraction, van der Waals forces, covalent bonding, ionic bonding, or any other type of bonding that allows the tether to interact with one or more anchor particles and become attached thereto. Certain anchor particles, for example, can acquire an anionic charge when placed in an aqueous solution so that a cationic tether like PDAC can readily bind to a plurality of such anchor particles by electrostatic interaction.

The target particles are often not anionic themselves, so more must be done than simply contacting them with cationic anchor particles or anchor particles bearing a cationic tether; in such an embodiment, the target particles can be given a negative charge so that they are attracted to the cationic tethering polymers. This can be done with an anionic polymer, such as (acrylic acid/acrylamide) copolymers, and their salts, which acts as an activating agent to clump together the target particles. The activating agent acts as a flocculant, presenting a mass of agglomerated, negatively-charged target particles to interact with the cationic anchor particles or the anchor particles bearing a cationic tether.

As used herein, the term “activation” refers to the interaction of an activating material, such as a polymer, with suspended particles in a liquid medium, such as an aqueous solution. An “activator polymer” can carry out this activation. In embodiments, high molecular weight polymers can be introduced into the particulate dispersion as Activator polymers, so that these polymers interact, or complex, with fine particles. The polymer-particle complexes interact with other similar complexes, or with other particles, and form agglomerates. This “activation” step can function as a pretreatment to prepare the surface of the fine particles for further interactions in the subsequent phases of the disclosed system and methods. For example, the activation step can prepare the surface of the fine particles to interact with other polymers that have been rationally designed to interact therewith in a “tethering” step. In another embodiment, activation can be accomplished by chemical modification of the particles. For example, oxidants or bases/alkalis can increase the negative surface energy of particulates, and acids can decrease the negative surface energy or even induce a positive surface energy on suspended particulates. In another embodiment, electrochemical oxidation or reduction processes can be used to affect the surface charge on the particles. In another embodiment of the activation step, hydrophobic modifiers can be used to prepare the surface of the fine particles for enhanced interaction with the anchor particles. These chemical modifications can produce activated particulates that have a higher affinity for anchor particles, tethers or tether-bearing anchor particles as described below. Negatively charged polymers can include anionic polymers can be used, including, for example, olefinic polymers, such as polymers made from polyacrylate, polymethacrylate, partially hydrolyzed polyacrylamide, and salts, esters and copolymers thereof (such as (sodium acrylate/acrylamide) copolymers), phosphonated polymers, sulfonated polymers, such as sulfonated polystyrene, 2-AMPS polymers, and salts, esters and copolymers thereof. In embodiments, these negatively charged polymers can act as activators for target particles. Positively charged polymers can include polyvinylamines, polyallylamines, polydiallyldimethylammoniums (e.g., the chloride salt), branched or linear polyethyleneimine, crosslinked amines (including epichlorohydrin/dimethylamine, and epichlorohydrin/alkylenediamines), quaternary ammonium substituted polymers, such as (acrylamide/dimethylaminoethylacrylate methyl chloride quat) copolymers and trimethylammoniummethylene-substituted polystyrene, and the like.

In embodiments, these positively charged polymers can act as tethers, to attach to anionic target particles or to attach to “activated” target particles that have been made anionic by the activation process. As tethers, these polymers attach the fine target particles to anchor particles, thereby forming removable complexes. In certain embodiments, a variety of hydrophobic modifiers can prepare the surface of the fine particles to form complexes with low density anchor particles such as gas bubbles. In embodiments, the hydrophobic modifiers make the activated particles easier to separate by flotation methods due to hydrophobic modifiers having a lower density than the aqueous fluid. Hydrophobic modifiers can include fatty acids, fatty acid salts, paraffin wax, slack wax, paraffins, 2-ethylhexanol, 2,2,4-Trimethyl-1,3-pentanediol monoisobutyrate, Texanol, 1,1,3-triethoxybutane, carbinols, methyl isobutyl carbinol, alkylamines, tallowamine, octylamine, octadecylamine, pine oil, tall oil, fuel oil, crude oil and the like.

2. Anchor Particles, Tethers and Activators in Water Treatment

In an embodiment, systems and methods for removing contaminants from a fluid stream are provided herein, comprising the steps of: (a) converting dissolved contaminants to an insoluble form, (b) contacting the contaminants with an anchor particle that has an affinity for the contaminants, and (c) removing the contaminants and anchor particles from the fluid stream.

In an embodiment, systems and methods for removing contaminants from a fluid stream are provided herein, comprising the steps of: (a) contacting the contaminants in the fluid stream with an oxidizing agent, thereby oxidizing the contaminants within the fluid stream, (b) contacting the oxidized contaminants with an anchor particle that has an affinity for the contaminants, and (c) removing the oxidized contaminants and anchor particles from the fluid stream.

In one embodiment, these systems and methods can be used to remove an oxidizable contaminant from a fluid stream. In this embodiment, an oxidizing agent is initially added into the stream of water containing a target contaminant, where the target contaminant precipitates when it oxidizes, forming an insoluble precipitate. The oxidizing agent and contaminant can react with the target contaminant in an appropriate vessel, such as a contact vessel, a fluid container, a sufficiently long length of tube or pipe, or the like, such that the target contaminant in the effluent from the vessel or conduit has reacted with the oxidizing agent to form the insoluble precipitate. The precipitate thus formed becomes the target particles to be removed by use of anchor particles, using the methodologies described above. In an embodiment, the target particles can be treated initially with an anionic “activator” polymer, so that the target particles bear a negative charge. The activated target particles are then contacted with anchor particles or tether-bearing anchor particles, forming removable complexes that comprise the target particles aggregated with the anchor particles. The removable complexes are removed from the water by a solid-liquid separation operation such as filtration, inclined mesh filtration, flotation or clarification, taking advantage of the sinking or floating properties of the anchor particle. Anchor particles can be selected for their ready removability from the water containing the contaminant following their incorporation into the removable complexes. Removable complexes can float or sink, or remain suspended in a fluid stream, depending upon the physical properties of the component anchor particles. Exemplary anchor particles more dense than the fluid stream can include materials like cellulose (e.g., paper pulp), diatomaceous earth, rice hulls, and cellulose acetate; exemplary anchor particles more dense than the fluid stream can include materials like gas bubbles or foamed plastics. The method used for separating the removable complexes from the fluid may depend upon the anchor particle that is selected. Cellulose-based removable complexes, for example, can be easily removed by a filter or screen. Sand-based removable complexes settle very quickly in water, making them easy to remove by either sedimentation or filtration. Bubble-based removable complexes can float to the surface, where they are removable by skimming or other mechanical means.

The oxidant used to oxidize the target contaminant can be either metered or added in excess. Oxidant addition can be controlled by measuring oxidant residual or oxidation-reduction potential (ORP) after the contact volume. Oxidant can also be added in excess. If needed, an oxidant removal step could be added in which excess oxidant is consumed before the product water is released from the treatment process.

In addition to oxidants, or in place of oxidants, other chemical means of precipitation can be used to form an insoluble precipitant from the target contaminant. In embodiments, the precipitant is selected so that it only precipitates with the target contaminant in the wastewater. Once all target contaminants have been made into insoluble precipitates, they must be removed from the wastewater. This can be done by any number of solid-liquid separation methods, from filtration to clarification.

3. Water Treatment Using Substrate-Modifier Technologies

Systems and methods using substrates with modifiers can be used for removing bacteria, dissolved metals, oil, suspended solids, and fine precipitates (e.g., insoluble oxidized contaminants) from water. The systems and methods for water treatment, described below, can be combined in any order, and with one or more of the treatment technologies in use. The treatment technologies, though described separately, can be used together in series or in parallel, and as a continuous process having multiple steps or treatment inputs, or as sequence of discontinuous processes. In embodiments, substrates for all selected treatment processes can be modified with two or more chemically different entities, creating a multifunctional particle for the purpose of sequestering multiple target contaminants.

As used herein, a substrate is a substance that provides a platform for the attachment of modifiers that are specific for the contaminant being removed. For particular treatments, the substrates are selected to provide advantageous attachment of modifiers for sequestering the specific contaminant. The substrate/modifier composition can be used as a treatment medium for removing contaminants from water. As examples of the substrate/modifier platform, the anchor particles system and the tether-bearing anchor particles system are described herein.

Particles useful as substrates (e.g., anchor particles) include materials denser than the fluid suspending the target contaminants, or materials that are less dense than that fluid. Examples of anchor particle substrates include quartz sand, diatomaceous earth (DE), cellulose acetate fibers, −20/+60 mesh rice hulls, −80 mesh rice hulls, polystyrene beads, bagasse, and the like. Substrates capable of supporting modifiers in accordance with these systems and methods can include organic or inorganic materials. Exemplary substrates, whether organic or inorganic, can be formed in any morphology, whether regular or irregular, plate-shaped, flake-like, cylindrical, spherical, needle-like, fibrous, etc. Substrate particles can include natural materials or synthetic materials, either as a single substance or as a composite.

Organic substrates can include fibrous material, particulate matter, amorphous material or any other material of organic origin. Organic substrates can include natural materials or synthetic materials. For example, synthetic organic substrates can include a variety of plastic materials. Both thermoset and thermoplastic resins may be used to form plastic substrates. Plastic substrates may be shaped as solid bodies, hollow bodies or fibers, or any other suitable shape. Plastic substrates can be formed from a variety of polymers. A polymer useful as a plastic substrate may be a homopolymer or a copolymer. Copolymers can include block copolymers, graft copolymers, and interpolymers. In embodiments, suitable plastics may include, for example, addition polymers (e.g., polymers of ethylenically unsaturated monomers), polyesters, polyurethanes, aramid resins, acetal resins, formaldehyde resins, and the like. Addition polymers can include, for example, polyolefins, polystyrene, and vinyl polymers. Polyolefins can include, in embodiments, polymers prepared from C₂-C₁₀ olefin monomers, e.g., ethylene, propylene, butylene, dicyclopentadiene, and the like. In embodiments, poly(vinyl chloride) polymers, acrylonitrile polymers, and the like can be used. In embodiments, useful polymers for the formation of substrates may be formed by condensation reaction of a polyhydric compound (e.g., an alkylene glycol, a polyether alcohol, or the like) with one or more polycarboxylic acids. Polyethylene terephthalate is an example of a suitable polyester resin. Polyurethane resins can include, e.g., polyether polyurethanes and polyester polyurethanes. Plastics may also be obtained for these uses from waste plastic, such as post-consumer waste including plastic bags, containers, bottles made of high density polyethylene, polyethylene grocery store bags, and the like. In embodiments, elastomeric materials can be used as substrates. Substrates of natural or synthetic rubber can be used, for example.

Natural organic substrates can comprise materials of vegetable or animal origin. Vegetable substrates can be predominately cellulosic, e.g., derived from cotton, jute, flax, hemp, sisal, ramie, and the like. Vegetable sources can be derived from seeds or seed cases, such as cotton or kapok, or from nuts or nutshells. Vegetable sources can include the waste materials from agriculture, such as corn stalks, stalks from grain, hay, straw, or sugar cane (e.g., bagasse). Vegetable sources can include leaves, such as sisal, agave, deciduous leaves from trees, shrubs and the like, leaves or needles from coniferous plants, and leaves from grasses. Vegetable sources can include fibers derived from the skin or bast surrounding the stem of a plant, such as flax, jute, kenaf, hemp, ramie, rattan, soybean husks, vines or banana plants. Vegetable sources can include fruits of plants or seeds, such as coconuts, peach pits, mango seeds, and the like. Vegetable sources can include the stalks or stems of a plant, such as wheat, rice, barley, bamboo, and grasses. Vegetable sources can include wood, wood processing products such as sawdust, and wood, and wood byproducts such as lignin. Animal sources of organic substrates can include materials from any part of a vertebrate or invertebrate animal, fish, bird, or insect. Such materials typically comprise proteins, e.g., animal fur, animal hair, animal hoofs, and the like. Animal sources can include any part of the animal's body, as might be produced as a waste product from animal husbandry, farming, meat production, fish production or the like, e.g., catgut, sinew, hoofs, cartilaginous products, etc. Animal sources can include the dried saliva or other excretions of insects or their cocoons, e.g., silk obtained from silkworm cocoons or spider's silk. Animal sources can be derived from feathers of birds or scales of fish.

Inorganic substrates useful as anchor particles in accordance with these systems can include one or more materials such as calcium carbonate, dolomite, calcium sulfate, kaolin, talc, titanium dioxide, sand, diatomaceous earth, aluminum hydroxide, silica, other metal oxides and the like. Examples of inorganic substrates include clays such as attapulgite and bentonite. In embodiments, the inorganic substrate can include vitreous materials, such as ceramic particles, glass, fly ash and the like. The substrates may be solid or may be partially or completely hollow. For example, glass or ceramic microspheres may be used as substrates. Vitreous materials such as glass or ceramic may also be formed as fibers to be used as substrates. Cementitious materials, such as gypsum, Portland cement, blast furnace cement, alumina cement, silica cement, and the like, can be used as substrates. Carbonaceous materials, including carbon black, graphite, lignite, anthracite, activated carbon, carbon fibers, carbon microparticles, and carbon nanoparticles, for example carbon nanotubes, can be used as substrates. In embodiments, inorganic materials are desirable as substrates. Modifications of substrate materials to enhance surface area are advantageous. For example, finely divided or granular mineral materials are useful. Materials that are porous with high surface area and permeability are useful. Advantageous materials include zeolite, bentonite, attapulgite, diatomaceous earth, perlite, pumice, sand, and the like.

As disclosed herein, gas bubbles can act as a substrate for forming anchor particles. Advantageously, gas bubbles can form floating removable complexes, allowing for the removal of the removable complexes from the surface of the fluid stream. Some other substrates for anchor particles may also form floating removable complexes, while others yet will have the tendency to sink or to remain suspended in the fluid stream (e.g., the aqueous solution). For example, substrates such as hollow spheres, porous materials, foamed materials and a variety of plastics, like gas bubbles, can have a density that is lower than the aqueous stream.

a. Substrate-Modifier Systems for Removing Bacteria

In embodiments, removal of bacteria from aqueous streams can be desirable. Contaminating bacteria can include aerobic or anaerobic bacteria, pathogens, and biofilm formers. In embodiments, a substrate and a modifier can be used for removing bacteria from processed water and surface water to prepare such water for other beneficial uses. The bacterial cells may be killed, disrupted, collected, or otherwise prevented from proliferating.

In embodiments, a substrate, as described above, can be selected to be modified with a modifier, thereby producing a modified substrate as a treatment medium. In embodiments, the substrate is a granular material with high surface area to offer high permeability to flow while providing efficient contact of the water with the modifier. In embodiments, the modifier can be a cationic material that can be deposited on the substrate by covalent, ionic, hydrophobic, hydrostatic interactions, or by saturation, coating, or deposition from a solution. Examples of modifiers include cationic polymers, cationic surfactants, and cationic covalent modifiers. Cationic polymers can include linear or branched polyethylenimine, poly-DADMAC, epichlorohydrin/DMA condensation polymers, amine/aldehyde condensates, chitosan, cationic starches, styrene maleic anhydride imide (SMAI), and the like. Cationic surfactants can include cetyltrimethylammonium bromide (CTAB), alkyldimethylbenzyl quats, dialkylmethylbenzylammonium quats, and the like. Cationic covalent modifiers can include quaternization reagents like Dow Q-188 or organosilicon quaternary ammonium compounds. Examples of the organosilicon quaternary ammonium compounds are 3-trihydroxysilylpropyldimethylalkyl (C6-C22) ammonium halide, 3-trimethoxysilylpropyldimethylalkyl (C6-C22) ammonium halide, 3-triethoxysilylpropyldimethylalkyl (C6-C22) ammonium halide, and the like. In other embodiments, the modifier can be an oxidizing compound such as potassium permanganate, sodium hypochlorite, and sodium percarbonate. The modified substrate can be coated with a hydrophobic layer to cause slow release of the oxidizer.

b. Substrate-Modifier Systems for Removing Dissolved Metals

In embodiments, removal of dissolved metals from aqueous streams can be desirable. Contaminating dissolved metals can include iron, zinc, arsenic, manganese, calcium, magnesium, chromium, copper, strontium, barium, radium, and the like. In embodiments, a treatment medium comprising a substrate and a modifier can be used for removing dissolved metals from surface water and produced water to prepare such water for use in hydraulic fracturing. The dissolved metals may be complexed, immobilized, precipitated, or otherwise removed from the fluid stream.

In embodiments, a substrate, as described above, is selected to be modified with a modifier, thereby producing a modified substrate as a treatment medium. The modifier is preferably capable of being immobilized onto the substrate by mechanisms of bonding, complexing, or adhering. In embodiments, the modifier can be a polymer that has an affinity for the surface of the substrate. In embodiments, the modifier can be applied to the substrate in the form of a solution. In embodiments, the modifier is insoluble in water after it is affixed to the substrate. In embodiments, the modifier has a metal chelating group, and can be deposited on the substrate by covalent, ionic, hydrophobic or hydrostatic interactions, or by saturation, coating, or deposition from a solution. Examples of modifiers include compounds or polymers containing anionic chelant functional groups selected from the list comprising phosphate, phosphonate, xanthate, dithiocarbamate, hydroxamate, carboxylate, sulfate, and sulfide. Examples of modifiers include fatty acids, fatty amides, and vinyl polymers with the above listed chelant groups. Examples of modifiers based on vinyl polymers include comonomers of vinylphosphonic acid, vinylidenediphosphonic acid, 2-acrylamido-2-methylpropane sulfonic acid (2-AMPS), acrylamide-N-hydroxamic acids, itaconic acid, maleic acid, and salts thereof. In embodiments, inorganic salts such as ferric chloride tetrahydrate can be used as modifiers.

c. Substrate-Modifier Systems for Removing Suspended Solids

Suspended solids are often removed from fluid streams by filtration or sedimentation. In the case of finely divided solids or colloids, however, sedimentation is slow and filtration can be difficult. While filtration technologies, for example, sand filtration, is known in the art to remove finely divided suspended solids from liquids, these contaminants have low affinity for the medium, so their removal can be inefficient. Conventional filtration methods are also subject to plugging, resulting in a decreased throughput or an elevated pressure. The substrate-modifier system enables the collection of fine particulates into a form that is more easily filtered, resulting in more efficient removal of the fine particulates.

In hydraulic fracturing, suspended solids in the frac fluid can cause formation damage, plugging and lost production. Hence, the removal of such substances from the frac fluid is desirable. Suspended solids can include materials like clays, weighting agents, barite, drilling muds, silt, and the like. In embodiments, a treatment medium comprising a substrate and a modifier can be used for removing suspended solids from surface water and produced water more rapidly and efficiently than currently-practiced technologies, to prepare such water for use in hydraulic fracturing.

In embodiments, a substrate, as described above, is selected to be modified with a modifier, thereby producing a modified substrate as a treatment medium. In embodiments, the substrate is a granular material with high surface area to offer high permeability to flow while providing efficient contact of the water with the modifier. Modifiers useful in the removal of suspended solids according to these systems and methods include cationic polymers, cationic surfactants and cationic covalent modifiers. Examples of cationic polymers include linear or branched polyethylenimine, poly-DADMAC, epichlorohydrin/DMA condensation polymers, amine/aldehyde condensates, chitosan, cationic starches, styrene maleic anhydride imide (SMAI), and the like. Examples of cationic surfactants include cetyltrimethylammonium bromide (CTAB), alkyldimethylbenzyl quats, dialkylmethylbenzylammonium quats, and the like. Examples of cationic covalent modifiers include quaternization reagents like Dow Q-188 or organosilicon quaternary ammonium compounds. Examples of the organosilicon quaternary ammonium compounds are 3-trihydroxysilylpropyldimethylalkyl (C6-C22) ammonium halide, 3-trimethoxysilylpropyldimethylalkyl (C6-C22) ammonium halide, 3-triethoxysilylpropyldimethylalkyl (C6-C22) ammonium halide, and the like.

d. Substrate-Modifier Systems for Removing Hardness

Hardness ions like Ca, Mg, Ba, Fe, Sr, and the like, can cause scaling and plugging of equipment and producing zones of the petroleum formation as a result of hydraulic fracturing operations. These multivalent cations also cause precipitation or higher dose requirements of certain additives needed in fracturing, for example friction reducing agents. For these reasons, elevated hardness is undesirable in frac water. Typical concentrations of hardness ions in fresh water sources are in the range of 20-250 mg/L as CaCO₃. Flowback water from a fracturing operation can contain much higher concentrations of hardness ions, up to 30,000 mg/L as CaCO₃, as a result of contacting underground sources of such materials.

Conventional treatments for softening water (i.e., removing hardness ions) include ion exchange, distillation, reverse osmosis (RO) desalination, and lime softening, and each has known disadvantages. Ion exchange requires periodic regeneration with brine and this corrosive brine is a handling and disposal issue. Distillation and RO are energy- and equipment-intensive. Lime softening is sometimes practiced on a large scale in municipal water treatment systems, but the process generates a lime sludge that is difficult to dewater and manage. To avoid some or all of these disadvantages, the systems and methods disclosed herein utilize a two-step process: 1) precipitation of hardness ions, and 2) removal of the precipitate with a substrate-modifier system.

In embodiments, the first step can involve precipitation of hardness ions by using an alkali source such as sodium carbonate, sodium bicarbonate, or sodium hydroxide. Treatment with the alkali causes formation of calcium carbonate crystals. The precipitation step can remove a variety of metals that contribute to hardness, including Ca, Mg, Ba, Sr, Fe, Cu, Ag, Ni, Cd, Cr, Zn, and Pb ions as precipitated carbonates or hydroxides, and the precipitated solids facilitate removal of other suspended solids, oil and bacteria. All of these solids are collected as a sludge and the resulting water is clarified. After the precipitation, the CaCO₃ particles need to be removed from the water to complete the treatment.

Removing the CaCO₃ particles can take place by contacting them with a substrate-modifier system. Advantageously, a mineral substrate can be used, with a size between 0.01-5 mm in diameter. The substrate particles can be modified with polymers such as linear or branched polyethylenimine, poly-DADMAC, epichlorohydrin/DMA condensation polymers, amine/aldehyde condensates, chitosan, cationic starches, and styrene maleic anhydride imide (SMAI). In other embodiments, the modifier polymers can be anionic types such as acrylamide/acrylate copolymers or carboxymethyl cellulose; or nonionic types such as polyacrylamide or dextran.

e. Substrate-Modifier Systems for Removing Oil and Organics

In embodiments, a treatment medium comprising a substrate and a modifier can be used for removing oil, dissolved organic compounds, and suspended organic compounds from water. In hydraulic fracturing, suspended or emulsified oil in the frac fluid can cause formation damage, plugging, microbial growth, and elevated demands for additive chemicals. Hence the removal of oil from frac fluid components is desirable. Contaminating oil in frac fluids can include oil from the petroleum reservoir, lubricants, or drilling fluid additives.

In embodiments, a substrate, as described above, is selected to be modified with a modifier, thereby producing a modified substrate as a treatment medium. In embodiments, the substrate is a granular material with high surface area to offer high permeability to flow while providing efficient contact of the water with the modifier. In embodiments, the modifier can be a hydrophobic cationic material that can be deposited on the substrate by covalent or ionic bonding. The modifier can be applied by saturation, coating, or deposition from a solution. Examples of modifiers include cationic polymers and cationic surfactants. In embodiments, the modifier can be an organosilicon quaternary ammonium compound. Examples of the organosilicon quaternary ammonium compounds are 3-trihydroxysilylpropyldimethylalkyl (C6-C22) ammonium halide, 3-trimethoxysilylpropyldimethylalkyl (C6-C22) ammonium halide, 3-triethoxysilylpropyldimethylalkyl (C6-C22) ammonium halide, and the like.

4. Oxidizing Agent Technologies

Systems and methods that provide oxidizing agents as part of a treatment system can involve four steps: (1) oxidizing the contaminant in the aqueous stream; (2) adding a treatment medium (i.e., a modified substrate) to collect the oxidized contaminants; (3) removing the oxidized particles from the aqueous stream; and (4) treating the aqueous stream to remove residual oxidants and other processing materials. Processes in accordance with these systems and methods can take advantage of the different solubilities of reduced and oxidized species of contaminants.

Oxidants suitable for use in accordance with these systems and methods include, in embodiments, common oxidants such as ozone, oxygen, chlorine, chlorite, hypochlorite, permanganate, hydrogen peroxide, organic peroxides, persulfate, perborate, N-halogenated hydantoin, nitric acid, nitrate salts, and the like. In embodiments, sodium percarbonate (Na₂CO₃.1.5H₂O₂) can be used for treating water, such as frac flowback water. When dissolved in water, this oxidant releases hydrogen peroxide and sodium carbonate. Hydrogen peroxide has high oxidation potential (1.8 V) and does not increase total dissolved solid after treatment. Sodium carbonate also reduces hardness and provides a source of alkalinity which facilitates the precipitation of some metal ions including ferric iron.

The oxidizing agent can be added to the system by different delivery mechanisms. For example, aqueous solutions of oxidants can be fed by pumping a feed solution at constant volumetric rate or on demand as determined by oxidation-reduction potential (ORP) or other detection scheme.

The use of some oxidants, such as hydrogen peroxide and bleach, can cause bubble generation within the system. One mechanism of bubble formation by hydrogen peroxide is the decomposition of peroxide in the presence of iron or enzymes such as catalase, causing the release of oxygen. Bleaching chemicals such as sodium hypochlorite can release chlorine-containing gases, including chloramines when reacting with residual ammonia or ammonium in the water. The gas bubbles generated by these reactions deposit themselves onto the flocs, and after sufficient bubble attachment the bubbles make the flocs buoyant and float.

In certain embodiments, the oxidant can be delivered in the form of a gas stream or bubbles, such as ozone, air, chlorine, and the like. The contact of the oxidant gas with the water stream can be facilitated by a sparger or diffuser, in which case the oxidant gas can serve as the oxidant, the anchor particle, or both. Alternatively, the oxidant can be delivered in a solid form such as tablets, granules, or a suspension. The delivery of the oxidant can be metered by limited solubility of a solid dosage form, or by controlled/delayed release of an encapsulated form. In other embodiments, the oxidation can be accomplished by means of an electrochemical method, such as passing the water through a reactor equipped with electrodes that deliver an applied voltage. The electrodes can be designed such that a sacrificial metal dissolves into the solution upon application of a voltage. Such systems are known in the art as electrocoagulation (EC) systems. In embodiments, the electrode material can be aluminum which dissolves upon application of voltage to release aluminum ions into solution.

As described above, for certain oxidized contaminants such as ferric hydroxide, filtration based on particle size is not effective. Accordingly, in embodiments, treatment media having a specific affinity for ferric hydroxide can be provided. In certain embodiments, the treatment media can include media containing the anchor particles, tethers and activators as described above. In embodiments, the anchor particles are used together with tether polymers to produce modified substrates that can collect the precipitate particles. These systems and methods using anchor particles, tether particles and optionally activator particles form removable complexes from the precipitated ferric hydroxide target particles, facilitating their removal.

### B. Oil Industry Applications

In embodiments, the systems and methods disclosed herein can be utilized for removing specific contaminants from oil industry wastewater. In embodiments, targeted sorbents can be used that have specific affinity for the contaminant in question. The targeted treatment media can be designed by providing a supportive substrate modified with one or more combinations of functional components. The substrate can act as a solid support, sorbent, reaction template and a coalescer. In embodiments, the substrate can comprise finely divided clays or minerals, porous granular minerals, high surface area suspensions, or biomass. In other embodiments, the substrate can be introduced in fluid form such as an immiscible liquid, an emulsion, or a soluble additive. The substrate can be prepared as a solid form, such as granular, powdered, fibrous, membrane, microparticle, or coating to be contacted with fluid streams bearing oil industry wastewater. In embodiments, the substrate can be pre-treated with hydrophilic or hydrophobic polymers.

In embodiments, the substrate can be modified by contacting a solution of the modifier with the substrate, either in a flow-through setting or a batch mixture. The modifier can be placed onto the substrate by chemical bonding, for example covalent, ionic, hydrophobic, or chelation type bonds. In another embodiment, the modifier can be placed onto the substrate by coating or saturation of the substrate with the modifier. One method of coating or saturating the substrate with modifier is to apply a liquid solution of modifier onto the substrate. In either method of modification, after contacting the substrate with the solution of modifier, the residual water or other solvent can be evaporated to leave a residue of modifier on the surface of the substrate. In embodiments, the substrate can be treated with a solution or suspension of the modifier in a fluid medium, where the modifier has an affinity for the substrate causing deposition onto the substrate. The residue can be a monolayer, a coating, a partial layer, a filling, or a complex.

In embodiments, the substrate bears modifier compounds that add the specific functionality to the targeted sorbent. For example, cationic modifiers can be used to remove anionic contaminants by charge attraction, aromatic modifiers can be used to remove aromatic contaminants by pi-pi stacking, chelating modifiers can be used to target metals, etc. As examples of metal chelants, compounds such as carboxylates, phosphonates, sulfonates, phenolics, hydroxamates, xanthates, dithiocarbamates, thiols, polypeptides, amine carboxylate, thiourea, crown ether, thiacrown ether, phytic acid, and cyclodextrin can be used. In embodiments, modifiers can be multifunctional. As an example, a cationic aromatic compound used as a modifier can absorb anionic and aromatic contaminants at the same time.

In embodiments, modifiers can be designed having high affinity for specific contaminants. As would be understood by those of skill in the art, combinatorial methods can be used to identify appropriate modifiers. By using combinatorial ligand libraries of metal ion complexes, for example, ligands can be selected for binding specific metal ions. In embodiments, ligands for binding metals can be selected whose bonds are reversible under certain conditions, such as by adjusting pH. Certain polypeptides, for example, demonstrate this behavior. Under these circumstances, metal ion chelation, for example as carried out by polypeptides, can be reversed by pH adjustment so that the metals can be reclaimed after being removed from the wastewater.

In embodiments, specifically selected or designed polypeptides and proteins can be used as modifiers for forming a targeted sorbent in accordance with these systems and methods. For example, metallothioneins (MTs) can be used as modifiers to be affixed to a substrate for sequestering metal ions. MTs are a superfamily of low molecular weight (MW ˜3500 to 14000 daltons) cysteine-rich polypeptides and proteins found in biological systems (e.g., animals, plants and fungi), where their purpose is to regulate the intracellular supply of essential heavy metals like zinc, selenium and copper ions, and to protect cells from the deleterious effects of exposure to excessive amounts of physiological heavy metals or exposure to xenobiotic metals (such as cadmium, mercury, silver, arsenic, lead, platinum) heavy metals. Typically MTs lack the aromatic amino acids phenylalanine and tyrosine. MTs bind these metals through the sulfhydryl groups of their cysteine (Cys) residues, with certain metal preferences in a given structure based on the distribution of these Cys residues. Due to their primary, secondary, tertiary and quaternary structures, these proteins have high ion binding selectivity. Metal ions in MT molecules can be competitively displaced by other metal ions that have stronger affinities to MT. Other peptides such as phytocheletins (PCs) (oligomers of glutathione) have a similar metal chelating function. MTs and PCs, or analogues thereof, can be covalently attached to hydrophilically modified supportive materials, such as mineral particles or natural plant fibers. The resulting functionalized materials can be used to remove specific selenium and zinc ions from refinery wastewater streams. In embodiments, other naturally derived or synthetically produced agents having heavy metal binding capabilities can be used as modifiers to form a targeted sorbent useful for specific heavy metals in refinery wastewater streams.

Other metal scavengers, for example, non-polymeric compounds, can be used as modifiers for forming a targeted sorbent in accordance with these systems and methods. In embodiments, small molecules can be used to sequester metal ions. As an example, taurine (2-aminoethanesulfonic acid), a naturally-occurring sulfonic acid derived from cysteine in biological systems, can complex with zinc, and may bind with other heavy metals such as lead and cadmium. It has no affinity for calcium or magnesium ions, though. A modifier like taurine would permit a targeted sorbent to have selective metal ion binding capability.

In embodiments, the modified substrate can be used as a treatment agent for removal of undesirable compounds from petroleum industry wastewaters. In one embodiment, the treatment agent can be a granular filter media that is enclosed in a pressure vessel, for example to allow a certain contact time with the process fluid such as wastewater. In another embodiment, the treatment agent can be a finely divided material that is contacted with a process stream with the treatment agent (complexed with contaminants) being allowed to separate by sedimentation, centrifugation, or filtration. In embodiments, the treatment agent can be formed into fibrous or loose fill material that is contacted with the process stream. In embodiments, the treatment agent can be a coating or membrane that removes contaminants from liquids that pass through or pass over the coating or membrane. The contaminants that complex with the treatment agent can then be removed from the process stream and disposed, recycled, incinerated or otherwise treated to render the contaminants immobilized or detoxified.

### C. Frac Water

In embodiments, the systems and methods for treating wastewater can be used for treating water for use in hydraulic fracturing. These systems and methods, while applicable to treating any water supply, are particularly advantageous for treating frac flowback water. For example, in hydraulic fracturing, dissolved metals in the frac fluid can cause formation damage, plugging, lost production and elevated demand for additive chemicals. Hence the removal of these dissolved metals from the frac fluid is desirable. In addition to the general purification problems for frac water, there is typically a high iron concentration that can be as high as 200-300 ppm; this should desirably be reduced to a concentration <5 ppm if the water is to be suitable for use in hydraulic fracturing.

As would be understood by those of ordinary skill in the art, different sets of treatment systems may be required for treating surface water (which tends to contain lower levels of contaminants and fewer kinds of contaminants) than for treating processed water. Arrangements of the individual treatment systems is modular, and can be organized in a circuit containing any number of filtration components to provide a sequential filtration pathway.

In embodiments, the oxidizing agent technologies previously described can be advantageously applied to removing undesirable ions from frac water. For example, ferrous and ferric ions as found in frac water, have different solubilities in water. At the pH of frac flowback water, for example between pH 4.0 and pH 7.0, Fe⁺⁺⁺ is much less soluble than Fe⁺⁺, forming a colloidal precipitate of Fe(OH)₃. This principle allows the iron in frac water to be rendered insoluble by oxidization, so that it can be removed. However, it is understood that the settling and coagulation of precipitated Fe(OH)₃ are very slow, especially in a continuous flow through process. The finely dispersed Fe(OH)₃ particles especially in colloidal forms are difficult to remove by filtration through conventional media like sand filters, zeolite filters, diatomaceous earth filters, filter cloth, filter screens, etc. Hence, systems and methods for removal of ferric hydroxide and other oxidized species from fluid streams are desirably incorporated in a process for treating fluid streams such as frac water.

In more detail, the systems and methods as described herein can treat fluid streams such as frac water to remove: 1) dissolved metals such as Fe²⁺; 2) finely dispersed insoluble oxidized metal particles such as Fe³⁺; and 3) finely dispersed insoluble oxidized metal particles that have had their surface contaminated with organic material.

1. Removal of Dissolved Metals from Frac Water

For the removal of only dissolved metal (e.g. ferrous iron), a suitable substrate (e.g. diatomaceous earth) and an oxidizing agent (e.g. hydrogen peroxide) can be added to the aqueous stream (e.g. frac flowback water) either simultaneously or in sequence. In this system, the oxidizing agent can react with the dissolved metal, precipitating finely dispersed insoluble particles of the oxidized metal species from the aqueous stream. In embodiments, an adjustment of the pH may be necessary subsequent to the oxidation step, to facilitate the precipitation of the insoluble species. Following the formation of the precipitate of the oxidized metal in particulate form, a modifier can be added to the solution, such as a flocculant (e.g. polyacrylamide—polyacrylic acid copolymer), that forms agglomerates of the finely dispersed oxidized metal particles. In an embodiment, the flocculated agglomerates coalesce around a substrate such as the diatomaceous earth or any other suitable substrate. These flocculated agglomerates can then be removed by conventional mechanical separation techniques. This technique can be performed either in a batch process or in a continuous flow through process, and it can be combined with other treatment methods to remove, for example, remove residual oxidants and other processing materials.

2. Removal of Dispersed Metal Oxide Particulate Matter without Additional Inorganic or Organic Contamination

When no dissolved metals are present, but only finely dispersed metal oxide particles, the oxidation and pH adjustment steps described above are not necessary. In this case the substrate and modifier can be added simultaneously or in sequence, and the resulting flocculated agglomerates can then be removed by conventional mechanical separation techniques. This technique can be performed either in a batch process or in a continuous flow through process.

3. Removal of Dispersed Metal Oxide Particulate Matter with Organic or Inorganic Contamination

Without being bound by theory, it is understood that deposits of hydrocarbon material, biological material, inorganic material (metal oxides, hydroxides and sulfides), or combinations thereof can form in pipes, equipment and formations used in hydrocarbon recovery, including produced water injection wells. These deposits, known in the art as “schmoo,” can nucleate around particulate matter found in equipment or wells, for example single particles such as proppants, formation sand, fines or other precipitants. The solid nucleating material can become oil-wet from a coating of surface-active chemicals like corrosion inhibitors that are used in the equipment or the wells. Once the solid material is oil-wet, it can attract a layer of hydrocarbons that can congeal into a sticky agglomeration that adheres to surfaces. Large agglomerates can settle out in tank bottoms, and smaller agglomerates can be transported through pipes or into equipment or into the formation, causing fouling.

When the surface of finely dispersed oxidized metal particles has been contaminated (e.g. with organic material, schmoo, or the like), adding a modifier as described above may not result in effective flocculation of the dispersed oxidized metal particles. In this case additional treatment is needed for successful removal of finely dispersed insoluble particles. In one embodiment where the aqueous stream contains finely dispersed ferric iron particles contaminated with organic material, the same procedure is used as was described for the removal of ferric iron particles without organic contamination. As an additional step, though, ferrous or ferric iron is also added to the fluid stream. This additional treatment step allows for the modifier to properly agglomerate the suspended insoluble oxidized metal particles, enabling their removal from the aqueous stream. In embodiments, further treatment steps may be taken as appropriate, for example adjusting the pH of the fluid stream, or treating the fluid stream with a surfactant that interacts with the organic-coated particles, thereby rendering their surfaces cationic or anionic so that they interact better with the modifier and/or substrate.

It may be envisioned that other types of contamination besides organic species may render the modifier-substrate system ineffective for removing finely dispersed metal particles from fluid streams. In such situations, additional treatment steps can be taken to deal with such contaminants as appropriate, for example treating the fluid stream with an acid or base (as appropriate) before the addition of the substrate and the addition of the oxidizing agent but before the addition of the modifier.

4. Removal of Resistant Iron Species

In certain cases, iron in wastewater can be particularly resistant to removal treatments. As an example, flowback water from various oil shale wells can demonstrate this resistance. Of note, certain fracturing operations for oil shale wells use predominately guar-based fluid in each of their fracking stages, up to 100% guar-based fluid. Without being bound by theory, it is possible that residual guar fragments can complex with the dissolved iron from the formation waters, making the iron harder to remove by chemical means. In support of this, our laboratory tests, set forth in the Examples below, indicate that ferrous iron in the presence of broken guar gel does not precipitate immediately after oxidization and neutralization.

In embodiments, compounds having high affinity for iron, such as sodium phosphate, can cause iron to precipitate when oxidation and neutralization alone are not sufficient to effect precipitation. The phosphate can target the iron and form insoluble iron phosphate. Phosphoric acid and sodium phosphate, for example, can cause chelated-iron precipitation. Other potential candidates include polyphosphates, silicates, sulfides, and sulfates. Accordingly, addition of such iron-binding compounds can assist with removal of resistant iron species, especially when complexation with guar fragments is thought to explain the resistant behavior.

5. Exemplary Water Treatment System

The FIGURE shows an embodiment of a water treatment system 100 using flotation to separate contaminants from frac water. As shown in the FIGURE, untreated water 102, such as flowback water or produced water, taken from its source 104 and is injected at a chemical injection point 108 with an oxidant formulation 110, comprising, for example oxidant and buffer, to precipitate the targeted contaminants in the untreated water 102. The oxidant formulation 110 may also comprise anchor particles less dense than the ambient fluid stream, or anchor particle precursors that produce anchor particles less dense than the ambient fluid stream. Examples of less-dense anchor particles include oil droplets or air bubbles; an anchor particle precursor can be an oxygen-releasing material like hydrogen peroxide that releases bubbles that then act as anchor particles. The fluid then passes to a mixing zone 112, where mixing of the fluid stream can allow the contaminants to fully precipitate and potentially to break the bubbles or droplets into smaller-sized pieces. Then an activator polymer 114 is added at a second chemical injection point 118 gather the contaminants together and to provide a place for the oil or air to collect. The fluid stream then passes to a second mixing zone 120, where the flocculation of the contaminants develops more fully, and where the flocculated contaminants can attach to the anchor particles to form removable complexes. The fluid stream then enters a separation zone 122, where the removable complexes float to the top, where they can be drawn off as sludge for disposal 124 and the treated water is drawn off the bottom and sent to an appropriate storage or recycling facility 128. The second mixing zone 120 should have fairly low shear in order to allow flocs to develop and attach to the anchor particles to form removable complexes, while the first mixing zone 112 can be of higher shear. In a typical process, the mixing in the first mixing zone 112 need only last between about 1-5 seconds, while the mixing in the second mixing zone 120 should be at least 20 seconds or more. Flotation promoters such as the hydrophobic modifiers disclosed above (for example, fatty acids, fatty acid salts, paraffin wax, slack wax, paraffins, 2-ethylhexanol, 2,2,4-Trimethyl-1,3-pentanediol monoisobutyrate, Texanol, 1,1,3-triethoxybutane, carbinols, methyl isobutyl carbinol, alkylamines, tallowamine, octylamine, octadecylamine, pine oil, tall oil, fuel oil, crude oil, and the like) can be added in either chemical injection point.

### EQUIVALENTS

As described herein, embodiments provide an overall understanding of the principles, structure, function, manufacture, and/or use of the systems and methods disclosed herein, and further disclosed in the examples provided below. Those skilled in the art will appreciate that the materials and methods specifically described herein are non-limiting embodiments. The features illustrated or described in connection with one embodiment may be combined with features of other embodiments. Such modifications and variations are intended to be included within the scope of the present invention. As well, one skilled in the art will appreciate further features and advantages of the invention based on the above-described embodiments. For example, while the embodiments disclosed herein have been applied to water treatment before use in hydraulic fracturing formations, it is understood that certain embodiments can be applied to the treatment of water or other fluid streams produced by or used in other processes, e.g., drinking water purification, irrigation water purification, treatment of water from agricultural runoff, treatment of water from industrial processes, treatment of effluents from municipal water treatment systems, and the like. The systems and methods disclosed herein, while advantageous for removing iron from water supplies such as frac water, can also be used for removal of other water contaminants, such as manganese, sulfur, hydrogen sulfide, mercaptans, and some organic compounds. As an additional benefit, the systems and methods disclosed herein can disinfect a water supply, by decreasing the concentration of viable bacteria and other pathogens therein. Accordingly, the invention is not to be limited by what has been particularly shown and described, but rather is to be delimited by the scope of the claims. All publications and references cited herein are expressly incorporated herein by reference in their entirety. The words “a” and “an” are replaceable by the phrase “one or more.”

### EXAMPLES

Materials

The following materials were used in the Examples below:

Zeolite (8/40 mesh) was supplied by Bear River Zeolite

Lupasol G20 was supplied by BASF

Styrene maleic anhydride imide (SMAI 1000) was supplied by Sartomer (now Cray Valley)

Anionic flocculant (Magnafloc LT30) was supplied by Ciba

Potassium permanganate, poly-DADMAC, lignin, phosphoric acid, urea, sand, sodium hydroxide, and sodium carbonate were supplied by Sigma Aldrich

Aldrich +50/−70 mesh sand, Celite 545 diatomaceous earth, Rice Hull Specialty products −80 mesh rice hull and −20/+80 mesh rice hull, bagasse fibers, Poly-fit bean bag filler

### Example 1

### Preparation of PDAC Modified Cellulose Acetate Anchor Particles

A 0.1% solution was made by dissolving 20% PDAC in water. Cellulose acetate was suspended in 1 l solution of 0.1% PDAC for 10 min while stirring the suspension. The solution was then drained and the substrate dried at 10° C. for ˜30 min.

### Example 2

### Preparation of PDAC Modified Anchor Particles

A 1% solution was made by dissolving 20% PDAC in water. The anchor particles were covered in this solution and the solution was stirred for 10-15 minutes. The solution was decanted away.

### Example 3

### Iron Hydroxide Suspension Preparation

A solution of iron (III) chloride with 500 ppm of iron was made in tap water. 1.168 g of FeCl3 were added to tap water such that the total solution mass is 799.98 g. Iron chloride solutions of lower concentration were made by diluting this stock solution. Once the desired solution concentration of iron chloride was made, drops of sodium hydroxide were added until the pH of the solution was between 6 and 8. At this time, a precipitate would be visible, ferric hydroxide.

### Example 4

### Flocculant Solution Preparation (0.1% Solution)

0.0499 g of Magnafloc LT-30 was placed in beaker, and 49.927 g of tap water was added. The solution was mixed by hand with a stir rod.

### Example 5

### Qualitative Capture Properties of Modified Anchors

A series of experiments were performed investigating the feasibility of several modified substrates. Each sample was prepared in a 40 mL sample vial using 30 grams of 100 ppm iron in the form of ferric chloride. The pH of each sample was raised to neutral with 1 molar sodium hydroxide (about 4-5 drops). A modified substrate of Examples 1 or 2 and 0.120 mL of 0.1% Magnafloc LT-30 (Example 4) were added to each sample, sometimes with the flocculant being added first, sometimes with the substrate added first. Mixing was performed by gently inverting the capped sample vial several times for about 20-30 seconds. Results are shown in Table 1 below.

TABLE 1

| | Mass | | Settling Rate |
|---|---|---|---|
| Modified Material | (g) | LT-30 Addition | (inches per minute) |
| None | N/A | N/A | 0.017 |
| None | N/A | First | 0.063 |
| None | N/A | First | 1.3 |
| Sand | .585 | First | 0.36 |
| Sand | .571 | Second | 0.28 |
| CA | .232 | Second | Fibers do not settle |
| DE | .297 | First | 0.31 |
| DE | .689 | Second | 0.023 |
| Rice Hull −20/+80 | 0.593 | Second | .070 |
| Rice Hull −80 | 0.470 | Second | .24 |
| CA | .224 | First | Fibers do not settle |
| CA | .038 | First | Fibers do not settle |
| Polystyrene beads | .027 | First | Poor |
| Bagasse | .8 | First | Poor |
| Unmodified Refined | 0.738 | None | 0.32 |
| Hardwood Pulp | | | |
| Unmodified Refined | .738 | Second | Fibers do not settle |
| Hardwood Pulp | | | |
| Unmodified Refined | .112 | Second | Fibers do not settle |
| Hardwood Pulp | | | |
| 1.05% DE | .302 | First | .36 |
| suspension | | | |
| 1.05% DE | 1.202 | First | .86 |
| suspension | | | |
| 1.05% DE | 1.223 | Second | .91 |
| suspension | | | |
| Unmodified Sand | .113 | Second | 1.62 |

### Example 6

### Varying Ferric Hydroxide Concentration and the Effect on Settling

Five 100 mL beakers were filled with 50 grams of different concentrations of iron chloride suspension: 5 ppm of iron, 10 ppm, 30 ppm, 100 ppm and 300 ppm. Each beaker was then treated with 1 molar sodium hydroxide, which was added dropwise until the pH of the solution was between 6 and 8. Precipitates were observed in all the beakers except the beaker with 5 ppm of iron, which appeared to be a pale yellow transparent solution. The beakers with 100 and 300 ppm iron settled completely, with the more concentrated beaker mostly settling within 1.5 minutes after mixing. The 30 ppm iron beaker did not settle as quickly, and 3 minutes after mixing there are still many particles in the bulk solution.

To each of the beakers, 0.200 mL of 0.1% Magnafloc LT-30 was added and the beakers were stirred for 1 minute. No change was observed in the beaker with 5 ppm of iron. The other beakers showed an increase in average particle size as the original particles agglomerated together. Settling rate was observed to increase with increasing iron concentration. Results are described in Table 2.

TABLE 2

| Iron | |
|---|---|
| Concentration | |
| (ppm) | Settling behavior after addition of LT-30 |
| 5 | No visible precipitate |
| 10 | Particles appear slightly larger, most particles still in |
| | suspension after 2 minutes of settling |
| 30 | Clumping of particles observed, about 50% still in |
| | suspension after 2 minutes of settling |
| 100 | Particle size increases upon adding the flocculant. Most |
| | of the floc settles in the first 20 seconds, with all settled |
| | after 90 seconds |
| 300 | Same as 100 ppm, excepting that the final clusters appear |
| | larger |

Each beaker then undergoes the following process. It is mixed for 15 seconds, and then 0.05 g of PDAC modified sand of Example 2 is added and the beaker is mixed for another 15 seconds. The resulting mixtures all settle more compactly. Results are described in Table 3.

TABLE 3

| Iron | |
|---|---|
| Concentration | |
| (ppm) | Settling behavior after addition of PDAC modified sand |
| 5 | Solution still yellow. Sand at bottom is yellow-orange |
| 10 | Most material settles out instantly, few clusters remain in |
| | bulk |
| 30 | Faster settling rate, more compact bed, sand has not |
| | grabbed everything |
| 100 | It takes 20-30 seconds for all the material to settle in |
| | more condensed area |
| 300 | Precipitate falls more condensed. Some of the larger flocs |
| | seem to have been broken apart. |

### Example 7

### Ferric Hydroxide Suspension of 100 Mg Fe/L

A ferric chloride solution of about 500 mg Fe per liter was made using tap water and 97% reagent grade ferric chloride from Aldrich. A sample from this stock iron solution was then diluted with tap water until the iron concentration was about 100 mg Fe per liter (about 4 g of water per 1 g of stock solution). Drops of 1-5 M NaOH were then added to the sample until the pH of the solution went above 6. At that point, a fine precipitate of reddish-orange particles was observed, ferric hydroxide particles.

### Example 8

### Measurement of Iron Concentration

Iron concentration was measured using a Hach DR2700 to perform the FerroVer method, which uses UV absorbance of 10 mL samples to calculate the amount of iron in solution. A sample of the iron solution being measured was diluted so that its estimated iron concentration was in range for the DR2700 to accurately measure (between 0 and 3 mg Fe/L). The solution concentration could then be calculated by multiplying by the dilution ratio.

### Example 9

### Preparation of a 0.1% Flocculant Solution

0.0411 g of Magnafloc LT-30 was placed in beaker, and 39.667 g of tap water was added. The solution was mixed with a stir bar on a stir plate for about two hours on the lowest settling until all precipitate and bubbles were gone.

### Example 10

### Preparation of Cellulose Slurry

Hardwood cellulose pulp (either refined or unrefined) at about 4-6% solids was added to a 250 mL beaker with about 100 g of tap water so that the cellulose solids content of the final concentration is about 0.2%. The beaker was then mixed by hand for about 30 seconds.

### Example 11

### Sequestration of Iron by Cellulose

An example of this process is the removal of ferric hydroxide from water by using hardwood cellulose pulp and a partially hydrogenated polyacrylamide Magnafloc LT-30.

About 400 mL of a 100 mg Fe/L ferric hydroxide suspension of Example 7 was prepared in a 600 mL beaker. As this beaker was mixed, about 100 mL of an about 0.2% cellulose slurry of Example 10 was added to the beaker and stirred for about a minute (Note that the iron concentration at this point is approximately 80 mg Fe/L). Then about 1.5 g of a 0.1% flocculant solution was added to the beaker and the beaker was stirred for about a minute. After this time, the beaker was poured through a 70 mesh (0.212 mm) screen. The filtrate was then sampled and the iron concentration measured by Example 8 to find that the iron concentration was between 0.5 and 2 mg Fe/L.

### Example 12

### Comparison of Order of Addition of Cellulose and Flocculant on Iron Sequestration by Cellulose

Two experiments using the methods of Example 11 were performed using refined hardwood pulp. In one of these, the order of addition of Magnafloc LT-30 and the cellulose slurry was reversed. Table 4 below shows that both removed similar amounts of iron. When cellulose was added first, the iron ultimately was evenly distributed along the fibers. When cellulose was added second, the iron was clumped in flocs that were unevenly distributed among the cellulose fibers.

TABLE 4

| | Iron concentration | Iron concentration of | % Iron |
|---|---|---|---|
| Order of addition | of Feed (mg Fe/L) | Filtrate (mg Fe/L) | removal |
| Cellulose, LT-30 | 77 | .99 | 99 |
| LT-30, cellulose | 81 | .96 | 99 |

Two experiments using the methods of Example 11 were performed. In one of these experiments, no cellulose was added. In another of these experiments, no LT-30 was added. The resulting iron removals indicate that the combination of cellulose and LT-30 is necessary to obtain the greatest percentage removal. These results are summarized in Table 5.

TABLE 5

| | | Iron concentration | |
|---|---|---|---|
| | Iron concentration | of Filtrate (mg | % Iron |
| Additives | of Feed (mg Fe/L) | Fe/L) | removal |
| Cellulose, LT-30 | 77 | .99 | 99 |
| LT-30 | 80 | 63 | 21 |
| Cellulose | 100 | 27 | 73 |

### Example 13

### Refined Versus Unrefined Hardwood

Four experiments using the methods of Example 11 were performed. Two of these were using refined hardwood and two of these were using unrefined hardwood pulp. Of each of the pairs, two different concentrations of pulp slurry were used. Table 6 shows the results of these experiments. These experiments show that, down to a ratio of cellulose to iron of about 1.6 to 1.7, the removal of iron by refined and unrefined hardwood pulp is almost identical.

TABLE 6

| | | Iron concentration | |
|---|---|---|---|
| Cellulose Pulp | Iron concentration | of Filtrate (mg | % Iron |
| added | of Feed (mg Fe/L) | Fe/L) | removal |
| 451 mg/L, refined | 77 | .99 | 99 |
| 131 mg/L, refined | 79 | 2.72 | 97 |
| 440 mg/L, unrefined | 78 | 2.48 | 97 |
| 134 mg/L, unrefined | 78 | 1.78 | 98 |

### Example 14

### Ferrous Chloride Solution

A solution of ferrous chloride was made at a concentration of 50 ppm Fe2+ (as Fe2+) by adding 98% pure iron (II) chloride (Sigma-Aldrich) to tap water. The pH was adjusted to 7.1 by adding 1M NaOH.

### Example 15

### Cellulose Slurry

A slurry of 0.5% refined hardwood pulp was produced by adding 14.2 g of a 3.5% slurry of Kraft hardwood pulp to a beaker and diluting the mixture to 100 g with distilled water.

### Example 16

### Flocculant Solution

A 0.05% solution of flocculant was produced by adding 0.117 g of DAF-50 (Polymer Ventures, 50% anionic high molecular weight polyacrylamide) to 234 g distilled water. The solution was mixed with a magnetic stirrer until uniform.

### Example 17

### Treating Ferrous Chloride Solution with Oxidizing Agent and Cellulose and Flocculant

100 ml of the ferrous chloride solution prepared in accordance with Example 14 was poured into a 300 ml beaker and stirred with a magnetic stir bar using a Cimarec magnetic stir plate at setting 8. To this solution was added 0.010 mL of a 50% hydrogen peroxide solution, and 2 mL of the cellulose slurry prepared in accordance with Example 15. After 1 minute, 0.400 ml of the flocculant prepared in accordance with Example 16 was added. After 1 minute, the resultant mixture was poured over a 70 mesh (212 micron) screen and the turbidity of the filtrate was measured with a Hach 2100P Turbidimeter. The measured turbidity was 11 NTU.

### Example 18

### Treating Ferrous Chloride Solution with Oxidizing Agent and Cellulose and Flocculant

A ferrous chloride solution prepared in accordance with Example 14 was stirred as described in Example 17 for two days. The resulting solution was then treated with oxidizing agent and cellulose as set forth in Example 17. The measured turbidity was 19 NTU.

### Example 19

### Treating Ferrous Chloride Solution with Cellulose and Flocculant

A ferrous chloride solution was prepared and stirred as described in Example 18. To this solution was added 2 mL of the cellulose slurry prepared in accordance with Example 15. The turbidity was measured as described in Example 17. The measured turbidity was 3.6 NTU.

### Example 20

### Produced Water Sample Properties

A sample of produced water was found to have the following properties: 125 ppm total iron, 41 ppm dissolved iron, 9.8% dissolved solids, pH 7.

### Example 21

### Treating Produced Water with Oxidizing Agent and Cellulose and Flocculant

The procedure set forth in Example 17 was performed on produced water, using 100 ml of produced water as described in Example 20. For the oxidizing agent, 0.03 ml of a 50% hydrogen peroxide solution was used. 4 ml of cellulose prepared in accordance with Example 15 was used, and 0.800 ml of the flocculant prepared in accordance with Example 16 was used. The measured turbidity was 46 NTU.

### Example 22

### Oxidizing Produced Water by Exposure to Room Air

A 400 ml sample of produced water as described in Example 20 was placed in a beaker, and was exposed to room air that was bubbled through it using an air stone and an aquarium pump for about two hours.

### Example 23

### Treating Produced Water with Oxidizing Agent and Cellulose and Flocculant

The procedure described in Example 21 was performed on produced water treated as set forth in Example 22. The measured turbidity was 210 NTU.

### Example 24

### Treating Produced Water with Cellulose and Flocculant

The procedure described in Example 23 was performed, but no hydrogen peroxide was added. The measured turbidity was 218 NTU.

### Example 25

### Making Synthetic Frac Flowback Water

A sample of flowback water was used that contained 75 ppm of iron, 0 ppm of dissolved iron, and 8.0% dissolved solids, pH 7. The suspended solids were allowed to settle. The supernatant was removed and treated by adding add 50 ppm Fe (as Fe) to it by adding 98% pure iron (II) chloride (Sigma-Aldrich).

### Example 26

### Treating Synthetic Frac Flowback Water with Oxidizing Agent and Cellulose and Flocculant

The procedure described in Example 17 was performed using the synthetic frac flowback water prepared in accordance with Example 25. The measured turbidity was 7.4.

### Example 27

### Air-Oxidizing the Synthetic Frac Flowback Water

400 ml of synthetic frac flowback water prepared in accordance with Example 25 was placed in a beaker and exposed to room air that was bubbled through it using an air stone and an aquarium pump for about two hours.

### Example 28

### Treating Synthetic Frac Flowback Water with Oxidizing Agent and Cellulose and Flocculant

A 100 ml sample of air-oxidized synthetic frac flowback water prepared in accordance with Example 27 was treated as described in Example 17. The measured turbidity was 102 NTU.

### Example 29

### Treating Synthetic Frac Flowback Water with Cellulose and Flocculant

The experiment performed in Example 18 was carried out without adding hydrogen peroxide. The measured turbidity was 95 NTU.

### Example 30

### Flowback Water Sample Properties

A sample of flowback water was found to have the following properties: 38 ppm total iron, 0 ppm dissolved iron, 2.5% dissolved solids, pH 7, Turbidity of 212.

### Example 31

### Flocculant Solution

A 0.1% solution of flocculant was produced by adding 0.100 g of DAF-50 (Polymer Ventures, 50% anionic high molecular weight polyacrylamide) to 100 g distilled water. The solution was mixed with a magnetic stirrer until uniform.

### Example 32

### Treating Flowback Water with Diatomaceous Earth

200 ml of flowback water described in Example 30 was placed into a graduated cylinder, and 0.010 mL of 50% H2O2 and 0.150 g of pool filter grade diatomaceous earth (DicaLite) was added. The end of the cylinder was plugged with a gloved hand and inverted three times. 0.400 ml of the flocculant solution described in Example 31 was added, and the cylinder was inverted another 10 times. The contents of the cylinder were allowed to settle for two minutes. The top 150 cc was decanted from the cylinder, and its turbidity was measured with the Hach 2100P Turbidimeter. The turbidity of the sample was 78 NTU. The iron content of this decanted specimen was measured Hach DR2700 using the FerroVer method. The iron concentration was 5.2 mg/L.

### Example 33

### Treating Flowback Water with Addition of Ferrous Chloride

To a 200 ml sample of flowback water described in Example 30 was added Add 0.0079 g of 98% iron (II) chloride. The procedure described in Example 32 was then performed. The measured turbidity was 26 NTU. The iron concentration was 1.8 mg/L.

### Example 34

### Treating Flowback Water with Addition of Ferrous Chloride

The experiment described in Example 33 was performed, with the addition of 0.0244 g 98% iron (II) chloride instead of the amount described in Example 33. The measured turbidity was 26 NTU. The iron concentration was 3.2 mg/L.

### Example 35

### Treating Flowback Water with Addition of Ferric Chloride

The experiment described in Example 33 was performed, with the addition of 0.0093 g of 97% iron (III) chloride instead of iron (II) chloride described in Example 33. The measured turbidity was 32 NTU. The iron concentration was 2.2 mg/L.

### Example 36

### Treating Flowback Water with Addition of Ferric Chloride

The experiment described in Example 33 was performed, with the addition of 0.0051 g of iron (III) hydroxide (Phos-ban) instead of the iron (II) chloride. The iron concentration was 7.2 mg/L.

### Example 37

### Treatment of Flowback Water

200 ml of the flowback water described in Example 30 was placed in a 250 ml graduated cylinder. 0.15 g of diatomaceous earth was added, and the cylinder was inverted three times. 0.08 ml of a 50% anionic high molecular weight polyacrylamide solution (0.05% SNF Flo-Pam 956 VHM) was added. The cylinder was inverted ten times and left to settle for two minutes. 190 cc of supernatant was poured off, leaving 10 ml of fluid in the 250 ml graduated cylinder. 200 ml of the flowback water from Example 30 was added to the remaining 10 ml in the cylinder. 0.15 g diatomaceous earth was added, and the mixture was inverted three times in the cylinder to mix it. An additional 0.8 ml of 0.05% SNF Flo-Pam 956 VHM was added, with the cylinder being inverted ten times to mix. The mixture was allowed to settle for two minutes. 150 ml of the supernatant was poured off and its iron concentration was measured as described in Example 32. Iron concentration was 5.4 mg/L.

### Example 38

### Coating Diatomaceous Earth with Iron (III) Hydroxide

11.5 g pool-filter grade diatomaceous earth (DE) was dispersed in 100 ml of deionized water. Separately, 20 ml of deionized water was boiled, and 0.186 g iron (III) chloride was added to the boiling water. This iron chloride solution was added to the DE slurry. The pH of the slurry was raised to 7, titrating with 1M NaOH. The DE was isolated from the slurry by vacuum filtering it in a 7 cm diameter Buchner funnel fitted with 1 micron filter paper. The filter cake was washed with 50 ml deionized water. The filter cake was collected and dried at 115° C. for 3 hours or until completely dry. This process yielded DE coated with iron (III) hydroxide.

### Example 39

### Iron Removal Using Iron-Coated DE

200 ml of the flowback water described in Example 30 was placed in a 250 ml graduated cylinder. 0.075 g of the iron-coated DE prepared in Example 38 was added to the cylinder, and the cylinder was inverted 3 times. 0.08 mL of 0.05% SNF Flo-Pam 956 VHM (50% anionic high molecular weight polyacrylamide) was added to the cylinder, and the cylinder was inverted ten times. The mixture was allowed to settle for two minutes. 150 ml of the supernatant was poured off and its iron concentration was measured as described in Example 32.

### Example 40

### Treating Flowback Water with Added Iron

0.0046 g of iron (III) oxide 99% pure from Sigma Aldrich was added to 200 mL of flowback water as described in Example 30. The procedure described in Example 32 was performed on this sample. The iron concentration was 11.7 mg/L.

### Example 41

### Treating Flowback Water with Added Iron and DE

200 ml of the flowback water described in Example 30 was placed in a 250 ml graduated cylinder. 0.0093 g of 97% iron (III) chloride was added. 0.015 g of DE was also added. The cylinder was inverted 3 times to mix. 0.08 mL of 0.05% SNF Flo-Pam 956 VHM (50% anionic high molecular weight polyacrylamide) was added to the cylinder, and the cylinder was inverted ten times. The mixture was allowed to settle for two minutes. 150 ml of the supernatant was poured off and its iron concentration was measured as described in Example 32. Iron concentration was 11.8 mg/L.

### Example 42

### Treating Flowback Water with Added DE and Iron-Coated DE

200 ml of the flowback water described in Example 30 was placed in a 250 ml graduated cylinder and 0.0093 g of 97% iron (III) chloride was added. 0.015 g of the iron-coated DE prepared in Example 38 was added to the cylinder, and the cylinder was inverted 3 times. 0.08 mL of 0.05% SNF Flo-Pam 956 VHM (50% anionic high molecular weight polyacrylamide) was added to the cylinder, and the cylinder was inverted ten times. The mixture was allowed to settle for two minutes. 150 ml of the supernatant was poured off and its iron concentration was measured as described in Example 32. Iron concentration was 6.8 mg/L.

### Example 43

### Preparing Iron Salt/DE Blend

In a small Flak-Tech cup, 12.1275 g of natural diatomaceous earth, Eagle Picher product MN-84, and 0.2475 g of ferrous chloride, anhydrous, were combined. They were mixed in a speed mixer for 10 seconds at 2500 rpm. The final blend was 98% DE and 2% ferrous chloride by weight.

### Example 44

### Treating Flowback Water with Fe/DE Dry Blend

200 ml of the flowback water described in Example 30 was placed in a 250 ml graduated cylinder, and 0.157 g of the Fe/DE dry blend prepared in Example 43 was added.

The cylinder was inverted 3 times to mix. 6.6 μL of 50% H₂O₂, 2 mL of 0.1M NaOH, and 800 μL of 0.05% FloPam AN 956 VHM from SNF were added, and the cylinder was inverted ten times. The mixture was allowed to settle for two minutes. 150 ml of the supernatant was poured off and its turbidity and iron concentration were measured as described in Example 32. Turbidity was 18.2 ntu and iron concentration was 1.70 mg/L.

### Example 45

### Preparation of Iron Salt/DE Blend as Slurry

2 g of the dry blend described in Example 43 was added to 18 ml DI water. This slurry was mixed using a magnetic stir bar and stir plate to keep the particles suspended.

### Example 46

### Treating Flowback Water with Fe/DE Dry Blend

100 ml of the flowback water described in Example 30 was placed in a 170 ml graduated cylinder. 0.75 mL of the 10% solids slurry described in Example 45 was added. The cylinder was inverted 3 times to mix. 3.3 μL of 50% H₂O₂, 1 mL of 0.1M NaOH, and 400 μL 0.05% Zetag 4145, (50% mol anionic acrylamide co-polymer supplied by BASF) were added, and the cylinder was inverted ten times. The mixture was allowed to settle for two minutes. 75 ml of the supernatant was poured off and its turbidity and iron concentration were measured as described in Example 32. Turbidity is 24.8 ntu and the iron is 0.57 mg/L.

### Example 47

### Preparing a Synthetic Frac Water

16.7 L tap water was poured into a 5 gallon bucket. 1 kg of NaCl and 249 g CaCl₂.2H₂O were added and mixed until dissolved, forming a synthetic brine. 1.83 g of ferrous chloride was added to the synthetic brine, forming a synthetic frac water.

### Example 48

### Continuous Processing of Frac Water

The synthetic frac water as prepared in Example 47 was treated 12.375 g of the Fe/DE dry blend described in Example 44. This solution was then oxidized with 551 μL of 50% H2O2, and its pH was adjusted to 7 with 5M NaOH. A continuous system was set up so that the synthetic frac water was moved by a peristaltic pump through an in-line static mixer, then through a length of tubing, and finally into a clarifier. Flocculent was added to the system via a syringe pump directly before the static mixer. The peristaltic pump was set to pump the synthetic frac water at 1.4 L/min and the syringe pump added flocculent at a rate of 2.8 mL/min. The overflow water collected from the clarifier was analyzed for residual iron and turbidity. Over a 4 minute run time, the residual iron was measured between 2.48-2.79 mg/L and the turbidity was measured at 14.0-17.8 ntu.

### Example 49

### Treating Synthetic Frac Water with Fe Salt/DE Blend and Cellulose

200 ml of the flowback water described in Example 47 was placed in a 250 ml graduated cylinder. 0.15 g of the iron salt/DE dry blend prepared in accordance with Example 43 was added. The cylinder was inverted 3 times to mix. 2 ml of a 0.75% unrefined hardwood pulp as added to the sample, with the cylinder inverted another three times to mix. 6.6 μL of 50% H₂O₂ and 80 μL of 5M NaOH were added and the cylinder was inverted three times to mix. 400 μL of 0.1% SNF Flo-Pam 956 VHM was added, and the cylinder was inverted ten times. The mixture was allowed to settle for two minutes. 150 ml of the supernatant was poured off and its turbidity and iron concentration were measured as described in Example 32. Turbidity was 23.1 ntu and the iron concentration was 2.81 mg/L.

### Example 50

### Treating Flowback Water with a Fe/DE Blend

In each of the following experiments, 100 ml of the flowback water described in Example 30 was placed in a 250 ml beaker. A magnetic stir bar was placed in the beaker and the beaker was placed on a magnetic stir plate. The stir plate was set to 7. The stirring sample was treated with 0.075 g of the Fe/DE dry blend prepared in Example 43, then treated with 3.3 μL of 50% H₂O₂, then treated with 40 μL 5M NaOH. The sample was then allowed to mix for a designated period of time. After mixing, the sample was transferred to a 170 mL graduated cylinder. Then 200 μL of 0.1% SNF Flo-Pam AN 956 VHM was added to the sample. The graduated cylinder was then inverted 10 times to mix. The sample was left to settle for 1 minute, after which 75 mL of the supernatant water was poured off. Turbidity and iron concentration were measured as described in Example 32. The results are set forth in Table 7 below.

TABLE 7

| | | Iron content of |
|---|---|---|
| Time mixing | Turbidity of supernatant | supernatant |
| 0 | 151 | 19.9 |
| 0.5 | 77.6 | 0.94 |
| 2.5 | 54.9 | 5.5 |
| 3.5 | 101 | 7.8 |
| 4.5 | 99.4 | 7.4 |

### Example 51

### Treating Flowback Water with a Fe/DE Blend

A slurry was prepared using 1 g of the ferrous chloride/DE blend described in Example 43 suspended in 9 g of deionized water. 100 ml of the flowback water described in Example 30 was placed in a 170 ml graduated cylinder. 0.75 ml of the slurry was added to the cylinder. The cylinder was inverted 3 times to mix. 3.3 μL of 50% H₂O₂ and 40 μL of 5M NaOH were added and the cylinder was inverted three times to mix. 400 μL of 0.05% SNF Flo-Pam 956 VHM was added, and the cylinder was inverted ten times. The mixture was allowed to settle for one minute. 75 ml of the supernatant was poured off and its turbidity and iron concentration were measured as described in Example 32. Turbidity was 24.8 ntu and the iron concentration was 0.57 mg/L.

### Example 52

### Flotation Promoter for Improved Collection of Suspended Solids

To 200 mL samples of oil field produced water with a total dissolved solids (TDS) of 302,000 ppm and 105 ppm Fe, add an anchor particle (98% natural diatomaceous earth MN-84 from Eagle Pitcher, 2% ferrous chloride from Sigma Aldrich), 8% hydrogen peroxide in water, and 15% sodium hydroxide in water. Each of these samples then had added various amounts of 0.1% lauric acid (LA) in isopropanol or 0.1% sodium laurate (NaL) in water added to act as a flotation promoter. Finally, a solution of 0.1% polyacrylamide polymer (Flopam EM 430) was added and mixed for 1 minute. Removable complexes were allowed to settle, and then the time it took for removable complexes to float was noted. The pH was between 7.5 and 7.8 for all runs. Removable complexes initially sunk and then floated. Increasing the flotation promoter concentration decreased the flotation time. The results are set forth in Table 8 below.

TABLE 8

| | Par- | H2O2 | NaOH | Float | Pro- | Pol- | |
|---|---|---|---|---|---|---|---|
| | ticle | | | Pro- | moter | ymer | Time to |
| Trial # | (g) | (μL) | (μL) | moter | (μL) | (μL) | float (s) |
| 1 | 0.152 | 200 | 800 | — | — | 800 | 90 |
| 2 | 0.149 | 200 | 1000 | LA | 100 | 800 | 90 |
| 3 | 0.152 | 200 | 800 | LA | 800 | 800 | 40 |
| 4 | 0.151 | 200 | 800 | NaL | 800 | 800 | 55 |
| 5 | 0.149 | 200 | 800 | NaL | 3000 | 800 | 30 |

### Example 53

### Preparation of Iron-Spiked Water

19.3 kg oil field produced water sample with a TDS of 302,000 ppm and 57.6 ppm Fe²⁺ was treated with 9.3 g MN-84 diatomaceous earth, 12.5 mL 8% hydrogen peroxide, and 66.4 mL 25% sodium hydroxide. This material was then pumped at 1.4 L/min while mixing, and 0.1% Flopam EM 430 was added at 5.6 mL/min in line. The fluid then passed through a static mixer and a long length of tube into a 2 gal vessel. Removable complexes were made of the solids in the system, which settled at the bottom of the vessel. Water overflowed the vessel into a bucket. 17.5 kg of the treated water was reserved, and then 15.5 g of ferrous sulfate heptahydrate was added. The pH was 8.5.

### Example 54

### Iron Removal from Water by Flotation of Sludge

The 200 mL samples of the iron-spiked water from Example 53 were treated using the chemicals mentioned in Example 52, except the particle was diluted to a 3.75% slurry and no hydroxide was added. The flotation promoter used was a mixture of 1% lauric acid in isopropanol. Chemicals were added in the same order as Example 52. The pH of the final water was neutral. Results showed that a lower dose of peroxide prevents flotation, and higher doses cause flotation to occur faster. Results also show that the removable complexes (“RCs”) sink after being disturbed, which suggests that agitation removes the bubbles from the removable complexes, causing them to sink. The results are set forth in Table 9 below.

TABLE 9

| | Slurry | H2O2 | NaOH | Promoter | Polymer | |
|---|---|---|---|---|---|---|
| Trial # | (mL) | (mL) | (mL) | (mL) | (mL) | Observation |
| 1 | 3 | 1 | — | — | 1 | RCs sink, wait 30s |
| | | | | | | and then all suddenly |
| | | | | | | float. Disturbing the |
| | | | | | | top causes some to |
| | | | | | | fall |
| 2 | — | 1 | — | — | 1 | RCs stay suspended |
| | | | | | | and then float. |
| | | | | | | Twisting beaker |
| | | | | | | makes some sink |
| 3 | — | 1 | — | 1 | 1 | RCs flow more |
| | | | | | | quickly than in Trial |
| | | | | | | 2. Twisting glass |
| | | | | | | makes some sink |
| 4 | 3 | .2 | — | — | 1 | RCs sink and do not |
| | | | | | | float overnight. No |
| | | | | | | dissolved iron |
| | | | | | | remains. |
| 5 | 3 | .3 | — | — | 1 | RCs sink, then float |
| | | | | | | after 4.5 min |

### Example 55

Phosphate buffer was prepared mixing 17.957 g sodium phosphate monobasic dihydrate (Aldrich), 35.819 g sodium phosphate dibasic (Aldrich), and 200.72 g distilled water. The pH of the buffer was 6.94.

### Example 56

0.2 g of ammonium persulfate (Aldrich) was added to 500 mL of Cambridge, Mass. tap water. A guar gel was then formed by injecting 2.8 mL of Progel 4.5 (International Polymerics) into the water while it was blended in a blender, and hydrating for 10 minutes. The pH of the gel was adjusted by adding 1.3 mL of 1 M sodium hydroxide to about 9.5-10. Approximately 5 mL of a 2% solution of sodium tetraborate decahydrate was then added and mixed, causing a gel to form passing the visual lip test (commonly used in the oilfield to evaluate guar gels). The gel was then placed into a sealed 1-L bomb reactor and placed in the oven at 121 Celsius for 4 hours. The sample was removed and cooled, and the measured viscosity on the OFI model 800 viscometer (R1B1 configuration at 300 RPM) was observed to be 1 cP. The sample was placed in a separator funnel to remove the liquid from the floating solids.

### Example 57

450 mL of a broken guar gel formed in accordance with Example 56 was treated with was treated with 0.103 g of ferrous chloride. The total iron of the solution was found to be 99 mg/L Fe.

100 mL samples were mixed in 250-mL beakers and treated with a 3.75% diatomaceous earth slurry of Example 45 for 1 minute. A phosphate solution of Example 55 was sometimes added instead and mixed for 1 minute. Then a 7% hydrogen peroxide solution, and a 25% sodium hydroxide solution was added and mixed for one minute. Finally, a 0.1% polyacrylamide (anionic) solution was added and mixed for 10 minutes. Once the contents settled, the supernatant was tested for residual iron. In Trial 3 in the table below, the mixing time of phosphate and peroxide were increased to 5 minutes. The results are set forth in Table 10 below.

TABLE 10

Trial

| | 0 | 1 | 2 | 3 |
|---|---|---|---|---|
| 3.75% DE slurry (mL) | — | 1.5 | — | — |
| Phosphate solution (mL) | — | — | 0.5 | 0.5 |
| 7% H2O2 (mL) | — | 0.1 | 0.1 | 0.1 |
| 25% NaOH (mL) | — | 0.1 | — | — |
| 0.1% polyacrylamide solution | — | 0.8 | 0.8 | 0.8 |
| (mL) | | | | |
| Remain Iron (ppm) | 99 | 92 | 9 | 5 |

### EQUIVALENTS

While this invention has been particularly shown and described with references to preferred embodiments thereof, it will be understood by those skilled in the art that various changes in form and details may be made therein without departing from the scope of the invention encompassed by the appended claims.

What is claimed:

1. A system for water treatment, comprising:
a dissolved-metals removal substrate-modifier system;
a suspended-solids removal substrate-modifier system; and
one or more systems selected from the group consisting of:
a. a bacteria-removal substrate modifier system;
b. a hardness-removal system;
c. an organic-removal or oil-removal substrate-modifier system; and
d. an oxidizing agent technology system.

2. The system of claim 1, further comprising an oxidizing agent technology system.

3. A system for removing an oxidizable target contaminant from a fluid, comprising:
an oxidizing agent, wherein adding the oxidizing agent to the oxidizable target contaminant forms an oxidized species that precipitates as an insoluble precipitate in the fluid;
a substrate that forms a removable complex with the insoluble precipitate, thereby sequestering the oxidizable target contaminant, and
a removal system for removing the removable complex from the fluid.

4. The system of claim 3, wherein the oxidizable target contaminant comprises iron.

5. The system of claim 3, wherein the substrate comprises diatomaceous earth.

6. The system of claim 3, wherein the insoluble precipitate is modified to form a flocculated precursor having affinity for the substrate, whereby flocculated precursor complexes with the substrate to form the removable complex.

7. The system of claim 6, wherein the removable complex comprises an agglomerate comprising the substrate and the flocculated precursor, the flocculated precursor comprising the insoluble precipitate.

8. The system of claim 3, wherein the substrate comprises a modified substrate.

9. The system of claim 8, wherein the modified substrate comprises anchor particles.

10. The system of claim 9, wherein the anchor particles are less dense than the fluid.

11. The system of claim 10, wherein the anchor particles comprise gas bubbles.

12. The system of claim 11, wherein the gas bubbles are formed by a chemical action of the oxidizing agent.

13. The system of claim 11, further comprising a hydrophobic modifier.

14. The system of claim 9, wherein the anchor particles are tether-bearing anchor particles.

15. The system of claim 3, further comprising an activator added to the fluid, wherein the activator binds to the insoluble precipitate.

16. The system of claim 3, wherein the removable complex comprises an anchor particle, a tether polymer attached thereto, and an activator that binds to the tether and that binds to the insoluble precipitate.

17. A method for removing a dissolved contaminant from a fluid stream, comprising:
converting the dissolved contaminant to an insoluble form;
introducing an anchor particle into the fluid stream, wherein the anchor particle has an affinity for the insoluble form to form a removable complex therewith; and
removing the removable complex from the fluid stream.

18. The method of claim 17, wherein the affinity of the anchor particle for the insoluble form is mediated by a tether polymer attached to the anchor particle.

19. The method of claim 17, wherein the anchor particle is less dense than the fluid stream.

20. The method of claim 17, wherein the anchor particle comprises gas bubbles.

21. The method of claim 17, further comprising adding an activator polymer to the fluid stream, wherein the activator particle attaches to the insoluble form to produce a flocculated complex attachable to the anchor particle.

22. The method of claim 17, wherein the dissolved contaminant comprises iron, and the step of converting the dissolved contaminant to the insoluble form comprises oxidizing the iron.

23. The method of claim 17, wherein the insoluble form is an insoluble precipitate.

24. The method of claim 17, wherein the removable complex comprises gas bubbles.

25. The method of claim 17, further comprising adding a hydrophobic activator to the fluid stream, wherein the hydrophobic activator attaches to the insoluble form to produce a hydrophobic complex attachable to the anchor particle.

26. A method for removing a metal ion species from a fluid stream, wherein the metal iron species is a soluble metal ionic species, comprising:
oxidizing the soluble metal ion species with an oxidizing agent to form an insoluble oxidized species;
flocculating the insoluble oxidized species to form flocculated particulates;
providing a substrate that has affinity for the flocculated particulates;
introducing the substrate into the fluid stream to contact the flocculated particulates, whereby contacting the substrate with the flocculated particulates forms a removable complex; and
removing the removable complex from the fluid stream, thereby removing the metal ion species.

27. The method of claim 26, wherein the metal ion species is a ferrous ion.

28. The method of claim 26, wherein the substrate comprises diatomaceous earth.

29. The method of claim 26, wherein the substrate is combined with an additive comprising the metal ion species in an oxidized or a reduced state.

30. The method of claim 29, wherein the substrate comprises diatomaceous earth and the additive comprises a ferrous ion.

31. The method of claim 29, wherein the substrate comprises diatomaceous earth and the additive comprises a ferric ion.

32. The method of claim 29, wherein the substrate is coated with the additive.

33. The method of claim 29, wherein the substrate is diatomaceous earth and the additive comprises a ferrous or a ferric ion.
